(19) United States
(12) Patent Application Publication
(10) Pub. No.: US 2026/0087784 A1
(43) Pub. Date: Mar. 26, 2026

(54) TRAINING IMAGE CURATION VIA HIDDEN FEATURE CONCATENATION

(71) Applicant: GE Precision Healthcare LLC, Waukesha, WI (US)

(72) Inventors: Ahana Gangopadhyay, San Ramon, CA (US); Dwijay Dhananjay Shanbhag, San Ramon, CA (US); Nomita Chandra, Milwaukee, WI (US); Ravi Soni, Livermore, CA (US); Gopal Biligeri Avinash, Concord, CA (US)

(21) Appl. No.: 18/895,747

(22) Filed: Sep. 25, 2024

(51) Int. Cl. G06V 10/774; G06V 10/72; G06V 10/74; G06V 10/762; G06V 10/776; G06V 10/82; G06V 20/70

(52) U.S. Cl. CPC G06V 10/774; G06V 10/72; G06V 10/761; G06V 10/762; G06V 10/776; G06V 10/82; G06V 20/70; G06V 2201/03

(57) ABSTRACT

Systems/techniques that facilitate training image curation via hidden feature concatenation are provided. In various embodiments, a system can access a plurality of medical images and a suite of first deep learning neural networks, wherein the suite of first deep learning neural networks can be pre-trained to perform respective inferencing tasks for inputted images depicting respective anatomies or generated by respective imaging modalities. In various aspects, the system can curate the plurality of medical images in preparation for training of a second deep learning neural network, based on generating for each of the plurality of medical images a respective concatenated embedding that is composed of hidden feature maps extracted from the suite of first deep learning neural networks. In various instances, the system can train, after such curation, the second deep learning neural network on the plurality of medical images.

### TECHNICAL FIELD

The subject disclosure relates generally to machine learning, and more specifically to training image curation via hidden feature concatenation.

### BACKGROUND

A deep learning neural network can be trained to perform an inferencing task on inputted medical images. In order for the deep learning neural network to achieve a satisfactory level of inferencing accuracy, the medical images on which the deep learning neural network is trained should be properly curated. When existing techniques are implemented, such curation can be performed with limited success.

Accordingly, systems or techniques that can address one or more of these technical problems can be desirable.

### SUMMARY

The following presents a summary to provide a basic understanding of one or more embodiments. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus or computer program products that facilitate training image curation via hidden feature concatenation are described.

According to one or more embodiments, a system is provided. The system can comprise a non-transitory computer-readable memory that can store computer-executable components. The system can further comprise a processor that can be operably coupled to the non-transitory computer-readable memory and that can execute the computer-executable components stored in the non-transitory computer-readable memory. In various embodiments, the computer-executable components can comprise an access component that can access a plurality of medical images and a suite of first deep learning neural networks, wherein the suite of first deep learning neural networks can be pre-trained to perform respective inferencing tasks for inputted images depicting respective anatomies or generated by respective imaging modalities. In various aspects, the computer-executable components can comprise a curation component that can curate the plurality of medical images in preparation for training of a second deep learning neural network, based on generating for each of the plurality of medical images a respective concatenated embedding that is composed of hidden feature maps extracted from the suite of first deep learning neural networks. In various instances, the computer-executable components can comprise a training component that can train, after such curation, the second deep learning neural network on at least some of the plurality of medical images.

According to one or more embodiments, a computer-implemented method is provided. In various embodiments, the computer-implemented method can comprise accessing, by a device operatively coupled to a processor, a plurality of medical images and a suite of first deep learning neural networks, wherein the suite of first deep learning neural networks can be pre-trained to perform respective inferencing tasks for inputted images depicting respective anatomies or generated by respective imaging modalities. In various aspects, the computer-implemented method can comprise curating, by the device, the plurality of medical images in preparation for training of a second deep learning neural network, based on generating for each of the plurality of medical images a respective concatenated embedding that is composed of hidden feature maps extracted from the suite of first deep learning neural networks. In various instances, the computer-implemented method can comprise training, by the device and after such curation, the second deep learning neural network on at least some of the plurality of medical images.

According to one or more embodiments, a computer program product for facilitating training image curation via hidden feature concatenation is provided. In various embodiments, the computer program product can comprise a non-transitory computer-readable memory having program instructions embodied therewith. In various aspects, the program instructions can be executable by a processor to cause the processor to access a plurality of medical images and a suite of first deep learning neural networks, wherein the suite of first deep learning neural networks can be pre-trained to perform respective inferencing tasks for inputted images depicting respective anatomies or generated by respective imaging modalities. In various instances, the program instructions can be executable to cause the processor to curate the plurality of medical images in preparation for training of a second deep learning neural network, based on generating for each of the plurality of medical images a respective concatenated embedding that is composed of hidden feature maps extracted from the suite of first deep learning neural networks. In various cases, the program instructions can be executable to cause the processor to train, after such curation, the second deep learning neural network on at least some of the plurality of medical images.

### DESCRIPTION OF THE DRAWINGS

FIG. 1 illustrates a block diagram of an example, non-limiting system that facilitates training image curation via hidden feature concatenation in accordance with one or more embodiments described herein.

FIG. 2 illustrates a block diagram of an example, non-limiting system including an image cleaning model that facilitates training image curation via hidden feature concatenation in accordance with one or more embodiments described herein.

FIGS. 3-5 illustrate example, non-limiting block diagrams showing how an image cleaning model can be implemented in accordance with one or more embodiments described herein.

FIG. 6 illustrates a block diagram of an example, non-limiting system including a plurality of concatenated embeddings and a curated training dataset that facilitates training image curation via hidden feature concatenation in accordance with one or more embodiments described herein.

FIGS. 7-8 illustrate example, non-limiting block diagrams showing how a plurality of concatenated embeddings can be generated in accordance with one or more embodiments described herein.

FIGS. 9-15 illustrate example, non-limiting block diagrams or flow diagrams showing how a curated training dataset can be generated via duplicate or outlier removal in accordance with one or more embodiments described herein.

FIGS. 16-19 illustrate example, non-limiting block diagrams or flow diagrams showing how a curated training dataset can be generated via cluster-based splitting in accordance with one or more embodiments described herein.

FIGS. 20-21 illustrate example, non-limiting block diagrams or flow diagrams showing how a curated training dataset can be generated via automated annotation in accordance with one or more embodiments described herein.

FIG. 22 illustrates an example, non-limiting block diagram showing how various machine learning models can be trained in accordance with one or more embodiments described herein.

FIG. 23 illustrates a flow diagram of an example, non-limiting computer-implemented method that facilitates training image curation via hidden feature concatenation in accordance with one or more embodiments described herein.

FIG. 24 illustrates a block diagram of an example, non-limiting operating environment in which one or more embodiments described herein can be facilitated.

FIG. 25 illustrates an example networking environment operable to execute various implementations described herein.

### DETAILED DESCRIPTION

The following detailed description is merely illustrative and is not intended to limit embodiments or application/uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

A deep learning neural network can be trained (e.g., in supervised fashion, in unsupervised fashion, in reinforcement learning fashion) to perform an inferencing task (e.g., classification, segmentation, regression) on inputted medical images. For example, the deep learning neural network can be configured to generate classification labels, segmentation masks, or regression results for medical images that are captured or generated by medical imaging equipment (e.g., by computed tomography (CT) scanners, by magnetic resonance imaging (MRI) scanners, by X-ray scanners, by ultrasound scanners, by positron emission tomography (PET) scanners, by nuclear medicine (NM) scanners), and those classification labels, segmentation masks, or regression results can be leveraged to provide diagnoses or prognoses for medical patients (e.g., humans, animals, or otherwise).

In order for the deep learning neural network to achieve a satisfactory level of inferencing accuracy, the medical images on which the deep learning neural network is trained should be properly curated. In other words, the inferencing accuracy that is achievable by the deep learning neural network can depend upon the quality of and substantive variety encompassed by those training medical images. For example, if those training medical images are not representative of or do not otherwise span the various types of image content that the deep learning neural network is likely to encounter during deployment, the deep learning neural network can exhibit restricted or limited generalizability (e.g., can accurately perform the inferencing task on real-world images that look like those training medical images, but cannot accurately perform the inferencing task on real-world images that look unlike those training medical images). As another example, if those training medical images are not properly annotated with ground-truths (e.g., if a training medical image has not been assigned a ground-truth or has been erroneously assigned an incorrect ground-truth), the deep learning neural network can exhibit stunted inferencing accuracy. As even another example, if those training medical images include large numbers of duplicates (e.g., repeated images), the deep learning neural network can be at increased risk of becoming overfitted.

Unfortunately, when existing techniques are implemented, curation of training medical images can be performed with limited success. Indeed, existing techniques generally facilitate curation of training medical images via embedding searches. That is, existing techniques generate, for each training medical image in a group of training medical images, an embedding (e.g., a latent vector representation), and such existing techniques then organize, categorize, prune, or otherwise curate the group of training medical images by comparing those embeddings with each other.

Some existing techniques generate embeddings via a single dedicated autoencoder. As the inventors of various embodiments described herein recognized, such existing techniques can suffer from various disadvantages. First, the single dedicated autoencoder can require its own training, which can be time-consuming or resource-intensive. To avoid excessive consumption of time or resources, the single dedicated autoencoder can be any available autoencoder that has already been trained to generate embeddings for images in any other suitable operating context (e.g., can be a medical-image-specific autoencoder that has previously been trained for any suitable purpose or project, or can instead be a general-image autoencoder that has previously been trained for any suitable purpose or project). However, as the present inventors realized, the pool of all available image autoencoders is a tiny fraction of the pool of all available machine learning models that have already been trained. In other words, in any given operational context, there can be very many available machine learning models that are already trained, but only a small percentage of them can be leveraged by existing techniques for performing data curation. Thus, a technician that desires to curate a training image dataset can be considered as having to facilitate such curation by using a severely limited or restricted set of possible choices from or among the pool of already-trained machine learning models that are available to the technician.

Second, regardless of whether the single dedicated autoencoder is trained from scratch or is instead chosen from a pool of already-trained autoencoders, the single dedicated autoencoder can be considered as having learned how to latently represent an inputted image according to an idiosyncratic perspective that can depend upon its own training images. In other words, the single dedicated autoencoder can be considered as knowing how to capture only some of the substantive content that is contained or present within that inputted image. So, there might be task-dispositive information within the inputted image that the single dedicated autoencoder cannot encode into an embedding. That task-dispositive information can thus be considered as being lost and unable to be leveraged for data curation.

To address this second issue, other existing techniques generate embeddings by summing together the outputs of multiple dedicated autoencoders. Each of those multiple dedicated autoencoders can be considered as having its own idiosyncratic perspective of any given image, and so summing the multiple embeddings that those multiple dedicated autoencoders produce for the given image can yield a summed embedding that represents a larger percentage of the substantive content of the given image than any single embedding could represent. Note that such other existing techniques emphasize that summation of embeddings is vastly superior to concatenation of embeddings. Indeed, such other existing techniques teach that summation of embeddings achieves comparable accuracy as concatenation of embeddings, but without the increase in dimensionality (and thus computer memory consumption) associated with concatenation. Although such summation can address the problem of idiosyncratic autoencoder perspective, the present inventors realized that such summation can exacerbate the problem of limited autoencoder availability. Indeed, in order for two or more embeddings to be summed, those two or more embeddings must be of the same dimensionality as each other. Thus, instead of requiring selection of one single autoencoder from a pool of available autoencoders, such other existing techniques require selection of multiple available autoencoders that are configured to generate the same size of embedding as each other. In other words, the available choices of autoencoders for facilitation of data curation can be even further restricted by such other existing techniques.

So, systems or techniques that can address one or more of these technical problems can be desirable.

Various embodiments described herein can address one or more of these technical problems. One or more embodiments described herein can include systems, computer-implemented methods, apparatus, or computer program products that can facilitate training image curation via hidden feature concatenation. In particular, when given a plurality of medical images on which it is desired to train a deep learning neural network to perform a given inferencing task, various embodiments described herein can involve curating the plurality of medical images for that training, by leveraging a suite of pre-trained vision models (e.g., suite of pre-trained deep learning neural networks that are configured to receive images as input) that are configured to perform respective inferencing tasks. Specifically, for each medical image, the suite of pre-trained vision models can be executed on that medical image. One or more hidden feature maps produced by each of the suite of pre-trained vision models during such execution can be extracted, and those extracted hidden feature maps can be concatenated together. Each of those hidden feature maps can be considered as a type of latent representation, and thus an embedding, of that medical image, notwithstanding that the pre-trained vision models might not be dedicated autoencoders (e.g., might instead be image classifiers, image segmenters, or image regressors). So, the concatenation of hidden feature maps can be referred to as a concatenated embedding of the medical image. In this way, various embodiments described herein can generate a respective concatenated embedding for each of the plurality of medical images, and those concatenated embeddings can accordingly be compared to each other so as to facilitate dataset curation (e.g., so as to remove duplicates or outliers, so as to ensure appropriate training-vs-validation data splits, so as to automatically assign ground-truths or identify wrongly-assigned ground-truths).

Such embodiments can facilitate training data curation without suffering from the concomitant shortcomings of existing techniques. Indeed, because hidden activation maps extracted from already-trained vision models can be considered as a type of image embedding, various embodiments described herein can facilitate embedding-based data curation without having to rely on or otherwise be limited to dedicated autoencoders. In other words, various embodiments described herein can be considered as allowing a much larger percentage or proportion of whatever pool of already-trained machine learning models are available in a given operational context to be leveraged for dataset curation, unlike existing techniques which are instead limited only to dedicated autoencoders (e.g., the herein-described concatenated embeddings can be generated from the hidden activation maps of image classifiers, image segmenters, image regressors, or any other suitable deep learning neural network that is configured to operate on images, even if dedicated image autoencoders are unavailable). So, when a technician desires to curate a plurality of medical images, various embodiments described herein can be considered as offering the technician an expanded or less restrictive set of possible choices from or among the pool of already-trained machine learning models that are available to the technician. Moreover, because various embodiments described herein can involve concatenation of embeddings rather than addition of embeddings, various embodiments described here are not limited to embeddings of identical dimensionality/size, unlike some existing techniques which instead rely on addition of embeddings (e.g., embeddings of different sizes can be concatenated together, but they cannot be added together). This can be considered as an additional degree of freedom that further expands the set of possible choices from or among the pool of all available/already-trained machine learning models for facilitating data curation. Furthermore, the present inventors experimentally verified that, contrary to some teachings of various existing techniques, a model that is trained on an image dataset that has been curated via concatenated embeddings can achieve higher inferencing accuracy than a model that has instead been trained on either lone embeddings or summed embeddings. In other words, various embodiments described herein can be considered as achieving concrete performance boosts over existing techniques.

Various embodiments described herein can be considered as a computerized tool (e.g., any suitable combination of computer-executable hardware or computer-executable software) that can facilitate training image curation via hidden feature concatenation. In various aspects, such computerized tool can comprise an access component, a cleaning component, a curation component, or a training component.

In various embodiments, there can be a plurality of medical images. In various aspects, each of the plurality of medical images can be any suitable pixel array or voxel array generated or captured by any suitable medical imaging modality (e.g., can be a CT scanned image; can be an X-ray scanned image; can be an MRI scanned image) and that depicts any suitable anatomical structures (e.g., organs, tissues, body parts, body cavities) or portions thereof of any suitable medical patient.

In various embodiments, there can be a suite of pre-trained vision models. In various aspects, each of the suite of pre-trained vision models can exhibit any suitable deep learning internal architecture. For example, any of the suite of pre-trained vision models can include any suitable numbers of any suitable types of layers (e.g., input layer, one or more hidden layers, output layer, any of which can be convolutional layers, dense layers, long short-term memory (LSTM) layers, transformer layers, non-linearity layers, pooling layers, batch normalization layers, or padding layers). As another example, any of the suite of pre-trained vision models can include any suitable numbers of neurons in various layers (e.g., different layers can have the same or different numbers of neurons as each other). As yet another example, any of the suite of pre-trained vision models can include any suitable activation functions (e.g., softmax, sigmoid, hyperbolic tangent, rectified linear unit) in various neurons (e.g., different neurons can have the same or different activation functions as each other). As still another example, any of the suite of pre-trained vision models can include any suitable interneuron connections or interlayer connections (e.g., forward connections, skip connections, recurrent connections).

Regardless of their internal architectures, each of the suite of pre-trained vision models can be configured to perform a respective inferencing task on any suitable inputted images. In various aspects, any of the suite of pre-trained vision models can be configured to operate on images having any suitable format, size, or dimensionality (e.g., can be configured to operate on two-dimensional pixel arrays, or can be configured to operate on three-dimensional voxel arrays). In various instances, any of the suite of pre-trained vision models can be configured to operate on images that are captured or generated by any suitable imaging modality (e.g., by a CT scanner, by an MRI scanner, by an X-ray scanner). In various cases, the inferencing task that any of the suite of pre-trained vision models is configured to perform can be any suitable computational, predictive task that can be performed on or with respect to an image. As some non-limiting examples, an inferencing task can be image classification (e.g., classifying or diagnosing a pathology depicted in a medical image), image segmentation (e.g., localizing the boundary of an anatomical structure or surgical implant depicted in a medical image), or image regression (e.g., denoising or enhancing resolution of a medical image, so as to aid diagnosis).

In various embodiments, each of the suite of pre-trained vision models can have been trained in any suitable fashion (e.g., in supervised fashion, in unsupervised fashion, in reinforcement learning fashion) on a respective training dataset to perform its respective inferencing task (hence the term “pre-trained”). In various aspects, the respective training dataset for a given pre-trained vision model can comprise any suitable number of training images, where a training image can be any suitable image on which that given pre-trained vision model can be executed (e.g., if the given pre-trained vision model is configured to operate on two-dimensional pixel arrays captured by CT scanners, then a training image for the given pre-trained vision model can be a two-dimensional pixel array captured by a CT scanner; if the given pre-trained vision model is instead configured to operate on three-dimensional voxel arrays captured by MRI scanners, then a training image of the given pre-trained vision model can instead be a three-dimensional voxel array captured by an MRI scanner). In various cases, the training dataset of the given pre-trained vision model can be unannotated (e.g., in such case, the given pre-trained vision model can have been trained in unsupervised or reinforcement learning fashion on its training dataset). In other cases, however, the training dataset of the given pre-trained vision model can be annotated (e.g., in such case, the given pre-trained vision model can have been trained on its training dataset in supervised fashion). That is, for each training image, the training dataset of the given pre-trained vision model can comprise a respective ground-truth annotation that corresponds to that training image. In various aspects, a ground-truth annotation can be any suitable electronic data that indicates a correct or accurate inferencing task result that is known to correspond to a respective training image. Accordingly, the format, size, or dimensionality of a ground-truth annotation can depend upon the respective inferencing task that the given pre-trained vision model is configured to perform (e.g., if the inferencing task of the given pre-trained vision model is image classification, then each ground-truth annotation used to train the given pre-trained vision model can be a correct or accurate classification label corresponding to a respective training image; if the inferencing task of the given pre-trained vision model is image segmentation, then each ground-truth annotation used to train the given pre-trained vision model can be a correct or accurate segmentation mask corresponding to a respective training image; if the inferencing task of the given pre-trained vision model is image regression, then each ground-truth annotation used to train the given pre-trained vision model can be a correct or accurate regression result corresponding to a respective training image).

In various embodiments, there can be an untrained vision model. In various aspects, the untrained vision model can exhibit any suitable deep learning internal architecture. For example, the untrained vision model can include any suitable numbers of any suitable types of layers (e.g., input layer, one or more hidden layers, output layer, any of which can be convolutional layers, dense layers, LSTM layers, transformer layers, non-linearity layers, pooling layers, batch normalization layers, or padding layers). As another example, the untrained vision model can include any suitable numbers of neurons in various layers (e.g., different layers can have the same or different numbers of neurons as each other). As yet another example, the untrained vision model can include any suitable activation functions (e.g., softmax, sigmoid, hyperbolic tangent, rectified linear unit) in various neurons (e.g., different neurons can have the same or different activation functions as each other). As still another example, the untrained vision model can include any suitable interneuron connections or interlayer connections (e.g., forward connections, skip connections, recurrent connections).

Regardless of its internal architecture, it can be desired to train the untrained vision model on the plurality of medical images, so as to perform any suitable inferencing task (e.g., image classification, image segmentation, image regression). To help ensure that such training is effective or efficacious, it can be desired to curate the plurality of medical images. In various cases, the computerized tool described herein can facilitate such curation.

In various embodiments, the access component of the computerized tool can electronically access the plurality of medical images. For instance, the access component can receive, retrieve, or otherwise obtain the plurality of medical images from any suitable centralized or decentralized data structures (e.g., graph data structures, relational data structures, hybrid data structures). Likewise, the access component can electronically access the suite of pre-trained vision models or the untrained vision model. For instance, the access component can electronically interface or communicate with (e.g., send electronic commands to, read electronic signals from) the suite of pre-trained vision models or the untrained vision model. In any case, the access component can be considered as a conduit through which other components of the computerized tool can electronically interact with (e.g., read, write, edit, copy, manipulate, execute, activate, deactivate, modify) the plurality of medical images, the suite of pre-trained vision models, or the untrained vision model.

In various embodiments, the cleaning component of the computerized tool can maintain, store, control, or otherwise access an image cleaning model. In various aspects, the image cleaning model can exhibit any suitable deep learning internal architecture. For example, the image cleaning model can include any suitable numbers of any suitable types of layers (e.g., input layer, one or more hidden layers, output layer, any of which can be convolutional layers, dense layers, LSTM layers, transformer layers, non-linearity layers, pooling layers, batch normalization layers, or padding layers). As another example, the image cleaning model can include any suitable numbers of neurons in various layers (e.g., different layers can have the same or different numbers of neurons as each other). As yet another example, the image cleaning model can include any suitable activation functions (e.g., softmax, sigmoid, hyperbolic tangent, rectified linear unit) in various neurons (e.g., different neurons can have the same or different activation functions as each other). As still another example, the image cleaning model can include any suitable interneuron connections or interlayer connections (e.g., forward connections, skip connections, recurrent connections).

Regardless of its internal architecture, the image cleaning model can be configured to perform image-cleaning on any suitable inputted images. In particular, the image cleaning model can be configured to receive as input a given image which might be partially obscured by overlaid text, logos, or legends, and to produce as output a clean version of that given image that lacks such overlaid text, logos, or legends. In some cases, the image cleaning model can be configured to localize and black-out such overlaid text, logos, or legends. In other cases, the image cleaning model can instead be configured to localize and in-paint over such overlaid text, logos, or legends. In any case, the cleaning component can accordingly execute the image cleaning model on each of the plurality of medical images, thereby yielding a respectively corresponding plurality of cleaned medical images. More specifically, for each medical image in the plurality of medical images, the cleaning component can feed the medical image to an input layer of the image cleaning model, the medical image can complete a forward pass through one or more hidden layers of the image cleaning model, and an output layer of the image cleaning model can compute a respective one of the plurality of cleaned medical images based on activations from the one or more hidden layers of the image cleaning model. Thus, the plurality of cleaned medical images can be considered as having the same respective visual contents (e.g., as depicting the same respective anatomical structures with the same spatial orientations) as the plurality of medical images, without being obscured by overlaid text, logos, or legends. In other words, such overlaid text, logos, or legends can be considered as no longer being present and thus no longer able to distract or cause spurious learning.

In various embodiments, the curation component of the computerized tool can generate a plurality of concatenated embeddings that respectively correspond to the plurality of cleaned medical images. In various aspects, the curation component can accomplish such generation, by leveraging the suite of pre-trained vision models. In particular, for each cleaned medical image in the plurality of cleaned medical images, the curation component can execute each of the suite of pre-trained vision models on that cleaned medical image. Such execution can yield a plurality of inferencing task results that all correspond to that cleaned medical image. More specifically, the cleaning component can feed that cleaned medical image to an input layer of each of the suite of pre-trained vision models, that cleaned medical image can complete a respective forward pass through one or more hidden layers of each of the suite of pre-trained vision models, and an output layer of each of the suite of pre-trained vision models can compute a respective inferencing task result (e.g., a respective classification label, a respective segmentation mask, a respective regression output) based on respective activations from the one or more hidden layers of each of the suite of pre-trained vision models. Now, in various cases, the plurality of inferencing task results can be ignored or discarded. However, during those executions, the curation component can extract from each of the suite of pre-trained vision models a respective hidden activation map, thereby yielding a plurality of hidden activation maps that all correspond to the cleaned medical image. In various instances, the curation component can concatenate that plurality of hidden activation maps together. Although the suite of pre-trained vision models need not contain dedicated autoencoders, each of the plurality of hidden activation maps can be considered as a latent space representation, and thus embedding, of the cleaned medical image. So, the concatenation of the plurality of hidden activation maps can be referred to as a concatenated embedding that collectively represents or captures (e.g., albeit in an unclear or not readily interpretable fashion) attributes of the cleaned medical image which respective ones of the suite of pre-trained vision models found to be dispositive with respect to their respective inferencing tasks. In other words, different ones of the suite of pre-trained vision models can have learned to look for or pay attention to different visual aspects of the cleaned medical image, and the concatenated embedding can be considered as encompassing latent representations of all of those different visual aspects. Note that, unlike addition, concatenation is not limited to same-dimensionality elements. So, different ones of the plurality of hidden activation maps can have different sizes or dimensionalities than each other. That is, the curation component can be considered as having unrestricted freedom to extract whichever hidden activation maps internally generated by the suite of pre-trained vision models are desired for creation of the concatenated embedding. In stark contrast, if addition of the plurality of hidden activation maps were instead employed, then each of the plurality of hidden activation maps would have to have the same size or dimensionality as each other, which would severely restrict which hidden activation maps could be extracted from the suite of pre-trained vision models.

In any case, the curation component can generate, via execution and hidden activation extraction of the suite of pre-trained vision models, a respective concatenated embedding for each of the plurality of cleaned medical images.

In various aspects, the curation component can curate the plurality of cleaned medical images, based on leveraging those concatenated embeddings. This can yield a curated training dataset that can be subsequently used to train the untrained vision model.

As a non-limiting example, the curation component can remove duplicates from the plurality of cleaned medical images based on the plurality of concatenated embeddings, and whatever remains of the plurality of cleaned medical images can be considered as the curated training dataset. Specifically, the curation component can iterate through each of the plurality of cleaned medical images. For any given cleaned medical image, the curation component can compute a respective similarity score (e.g., cosine similarity) between the concatenated embedding of that given cleaned medical image and the concatenated embedding of each remaining cleaned medical image in the plurality of cleaned medical images. In various cases, the curation component can accordingly remove from the plurality of cleaned medical images whichever remaining cleaned medical images have a similarity score that indicates more than any suitable threshold amount of similarity. In some cases, the curation component can perform such duplicate removal on the entirety of the plurality of cleaned medical images. In other cases, the curation component can instead perform such duplicate removal on a class-wise basis. That is, rather than computing cosine similarities between the concatenated embedding of the given cleaned medical image and the concatenated embedding of every other cleaned medical image, the curation component can instead compute cosine similarities between the concatenated embedding of the given cleaned medical image and the concatenated embedding of every other cleaned medical image that belongs to a same class (e.g., same anatomy class, same modality class, same pathology class, same view class) as the given cleaned medical image. In this way, duplicated or nearly-duplicated images can be removed from the plurality of cleaned medical images, so as to help avoid overfitting.

As another non-limiting example, the curation component can remove outliers from the plurality of cleaned medical images based on the plurality of concatenated embeddings, and whatever remains of the plurality of cleaned medical images can be considered as the curated training dataset. In particular, the curation component can iterate through each of the plurality of cleaned medical images. For any given cleaned medical image, the curation component can compute a mean pairwise similarity score (e.g., mean pairwise cosine similarity) between the concatenated embedding of that given cleaned medical image and the concatenated embeddings of all the remaining cleaned medical images in the plurality of cleaned medical images. In various cases, the curation component can accordingly remove from the plurality of cleaned medical images whichever cleaned medical images have a mean pairwise similarity score that is below any suitable threshold amount of similarity. In some cases, the curation component can perform such outlier removal on the entirety of the plurality of cleaned medical images. In other cases, the curation component can instead perform such outlier removal on a class-wise basis. That is, rather than computing cosine similarities between the concatenated embedding of the given cleaned medical image and the concatenated embedding of every other cleaned medical image, the curation component can instead compute cosine similarities between the concatenated embedding of the given cleaned medical image and the concatenated embedding of every other cleaned medical image that belongs to a same class as the given cleaned medical image. In this way, any excessively outlying images can be removed from the plurality of cleaned medical images, so as to help avoid distorted or skewed learning.

As even another non-limiting example, the curation component can intelligently separate the plurality of cleaned medical images into a curated training dataset and a validation dataset, based on the plurality of concatenated embeddings. Specifically, the curation component can separate (e.g., via hierarchical clustering or density-based clustering) the plurality of cleaned medical images (or each subclass within the plurality of cleaned medical images) into a plurality of clusters (which need not be equally sized), based on how similar or dissimilar the plurality of concatenated embeddings are to each other. In various aspects, the curation component can accordingly split the plurality of cleaned medical images into the curated training dataset and the validation dataset, such that the curated training dataset contains a given percentage of each of the plurality of clusters, and such that the validation dataset contains a remainder of each of the plurality of clusters. In this way, the various substantive visual contents of the validation dataset can be considered as being equivalent or proportional to the various substantive visual contents of the curated training dataset, so as to help ensure appropriate model evaluation after training.

As yet another non-limiting example, the curation component can intelligently assign ground-truth annotations to various of ones of the plurality of cleaned medical images, based on the plurality of concatenated embeddings. In particular, some of the plurality of cleaned medical images can already be assigned to respective ground-truth annotations (e.g., ground-truth classification labels, ground-truth segmentation masks, ground-truth regression outputs), whereas others of the plurality of cleaned medical images can instead not yet be assigned to respective ground-truth annotations. So, the curation component can iterate through each unannotated cleaned medical image. For any given unannotated cleaned medical image, the curation component can identify an already-annotated cleaned medical image whose concatenated embedding is most similar to, or is within a same cluster as, the concatenated embedding of that given unannotated cleaned medical image. Accordingly, the curation component can cause that given unannotated cleaned medical image to become newly annotated, by assigning to it whatever ground-truth annotation corresponds to that identified annotated cleaned medical image. In this way, ground-truth annotations can be automatically assigned to unannotated ones of the plurality of cleaned medical images, so as to help reduce the amount of manual curation effort required from technicians.

In some cases, the curation component can implement any suitable combination of the above-mentioned curation techniques (e.g., duplicate removal, outlier removal, clustering, auto-annotation) to generate the curated training dataset.

In various embodiments, the training component of the computerized tool can train the untrained vision model on the curated training dataset. In various aspects, such training can be accomplished in any suitable fashion (e.g., supervised fashion, unsupervised fashion, reinforcement learning fashion).

Various embodiments described herein can be employed to use hardware or software to solve problems that are highly technical in nature (e.g., to facilitate training image curation via hidden feature concatenation), that are not abstract and that cannot be performed as a set of mental acts by a human. Further, some of the processes performed can be performed by a specialized computer (e.g., medical imaging scanners, computer vision machine learning models) for carrying out defined acts related to machine learning.

For example, such defined acts can include: accessing, by a device operatively coupled to a processor, a plurality of medical images and a suite of first deep learning neural networks, wherein the suite of first deep learning neural networks are pre-trained to perform respective inferencing tasks for inputted images depicting respective anatomies or generated by respective imaging modalities; curating, by the device, the plurality of medical images in preparation for training of a second deep learning neural network, based on generating for each of the plurality of medical images a respective concatenated embedding that is composed of hidden feature maps extracted from the suite of first deep learning neural networks; and training, by the device and after such curation, the second deep learning neural network on at least some of the plurality of medical images. In various aspects, the curating can comprise: identifying, by the device, two or more medical images having concatenated embeddings that are within a threshold margin of similarity of each other; and removing, by the device, all but one of those two or more medical images from the plurality of medical images. In various instances, the curating can comprise: identifying, by the device, one or more medical images having concatenated embeddings whose mean pairwise similarities with concatenated embeddings of others of the plurality of medical images are below a threshold margin; and removing, by the device, those one or more medical images from the plurality of medical images. In various cases, the curating can comprise: separating, by the device, the plurality of medical images into two or more clusters of medical images according to their concatenated embeddings; forming, by the device, a training dataset that includes a first percentage of each of the two or more clusters of medical images, wherein the device trains the second deep learning neural network on the training dataset and not on a remainder of the plurality of medical images; and validating, by the device, the second deep learning neural network on the remainder of the plurality of medical images after training. In various aspects, a first medical image in the plurality of medical images can correspond to a first ground-truth annotation, two or more second medical images in the plurality of medical images can lack ground-truth annotations, and the curating can comprise: identifying, by the device, which of the two or more second medical images have concatenated embeddings that are within a threshold margin of, or that are in a same cluster as, that of the first medical image; and assigning, by the device, the first ground-truth annotation to such identified ones of the two or more second medical images. In various instances, such defined acts can include removing, by the device, via execution of a third deep learning neural network, and prior to curation of the plurality of medical images, text, legends, or logos that are superimposed over respective ones of the plurality of medical images.

Such defined acts are not performed manually by humans. Indeed, neither the human mind nor a human with pen and paper can: electronically extract hidden activations from pre-trained vision models; electronically generate concatenated embeddings for medical images using those hidden activations; electronically curate those medical images based on those concatenated embeddings (e.g., by removing duplicates or outliers; by splitting clusters into proportional training and validation sets; by automatically tagging medical images with ground-truth annotations); and electronically train an untrained vision model on the medical images after such curation. Indeed, medical images are pixel arrays or voxel arrays that are captured by inherently-computerized, hardware-based scanners (e.g., CT scanners, X-ray scanners, MRI scanners). Such pixel arrays and voxel arrays cannot be created by the human mind without computers. Additionally, deep learning neural networks (e.g., pre-trained or untrained vision models; an image cleaning model) are inherently computerized, software-based constructs that cannot be meaningfully trained or executed in any way by the human mind without computers. Furthermore, curating a plurality of medical images (e.g., via duplicate removal, outlier removal, cluster-based splitting, or automatic annotating) by executing various deep learning neural networks is an inherently computerized process that cannot be implemented in any way whatsoever outside of a computing context. Accordingly, the computerized tool encapsulated by various embodiments described herein for facilitating training image curation via hidden feature concatenation is likewise inherently-computerized and cannot be implemented in any sensible, practical, or reasonable way without computers.

Moreover, various embodiments described herein can integrate into a practical application various teachings relating to the field of machine learning. As described above, it can be desired to train a given neural network to perform some inferencing task on a collection of medical images. In order for that training to be effective, the collection of medical images should first be curated. Some existing techniques facilitate such curation by generating embeddings for the collection of medical images using a single autoencoder. Because that single autoencoder can require its own training, such existing techniques will often recycle (e.g., use without re-training or fine-tuning) a single autoencoder that has already been trained (e.g., for any suitable past project) to receive as input an image and to produce as output an embedding for that image. Unfortunately, however, autoencoders usually make up only a small fraction of the set of already-trained machine learning models that are available to any given technician. So, a technician that desires to curate the collection of medical images can be considered as having a severely limited or restricted choice from among those already-trained machine learning models. Additionally, no matter which single autoencoder is ultimately chosen to facilitate curation according to existing techniques, that single autoencoder can be considered as only having learned how to capture, embed, or encode certain visual characteristics that can depend upon the specific images on which that single autoencoder was trained. Thus, the collection of medical images might contain certain visual information that the single autoencoder might be unable to encapsulate or encode into embeddings, and so that certain visual information can be unable to be leveraged for curation.

Other existing techniques attempt to address this encoding issue by generating for each medical image an aggregated embedding that is equal to the sum of multiple embeddings produced by multiple autoencoders. Different ones of those multiple autoencoders can be considered as knowing how to capture, encode, or embed different types of visual characteristics, and so summing the embeddings produced by those multiple autoencoders can be considered as a way to capture more of those visual characteristics that any single embedding could capture alone. However, such other existing techniques can be considered as imposing an embedding size constraint that further restricts or limits a technician's choice from among a set of available/already-trained machine learning models (e.g., summation of multiple embeddings requires equally-sized embeddings, and thus requires selection of multiple autoencoders that are configured with equally-sized output layers).

Various embodiments described herein can address one or more of these technical problems. In particular, the present inventors realized that curation of training medical images can be more effectively performed by generating embeddings for those training medical images, where those embeddings are concatenations of hidden feature maps produced by any suitable pre-trained vision models. Indeed, the present inventors realized that a hidden feature map produced by a hidden layer, rather than an output layer, of a vision model (e.g., of a neural network that is configured to operate on images) can be considered or treated as a type of image embedding, notwithstanding that the vision model might not be an autoencoder (e.g., the vision model might instead be an image classifier, or an image segmenter, or an image regressor). So, the present inventors devised various techniques described herein, in which the embeddings of autoencoders can be eschewed in favor of the hidden activation maps of any suitable vision models. In this way, a technician that desires to curate a collection of medical images can be considered as having a less limited or less restricted choice from among a set of already-trained machine learning models as compared to existing techniques (e.g., existing techniques are constrained only to pre-trained autoencoders; in stark contrast, various embodiments described here can be implemented via any suitable pre-trained machine learning models that are configured to receive an image as input; and the set of all pre-trained autoencoders that are available to the technician is necessarily smaller than the set of all pre-trained machine learning models configured to receive an image as input that are available to the technician).

Additionally, some existing techniques, as mentioned above, require summation of multiple embeddings for each medical image. Indeed, such existing techniques emphasize that summation of embeddings is vastly superior to concatenation of embeddings, since such summation purportedly achieves comparable accuracy as concatenation, but without the increase in dimensionality (and thus without a commensurate increase in computer memory consumption) associated with concatenation. Thus, existing techniques can be considered as teaching away from or otherwise against various embodiments described herein, since various embodiments described herein involve concatenation of embeddings rather than summation of embeddings. Implementation of concatenation rather than addition can be considered as providing at least two benefits or advantages.

First, because concatenation does not require identically-dimensioned elements (unlike addition which does require identically-dimensioned elements), various embodiments described herein can be facilitated via any suitable pre-trained vision models, even by pre-trained vision models that generate differently-dimensioned hidden feature maps than each other. This can be considered as providing even more freedom regarding a technician's choice of pre-trained vision model (e.g., some existing techniques restrictively require that the technician choose multiple autoencoders each having the same size of output layer, which can often be a very small proportion of all pre-trained vision models that are available to the technician; in stark contrast, various embodiments described here can function even with vision models that are not autoencoders and even with vision models that generate differently-sized hidden feature maps than each other, thereby allowing any available pre-trained vision models to be chosen by the technician to facilitate curation).

Second, the present inventors experimentally verified that, contrary to some teachings of various existing techniques, a machine learning model that is trained on a collection of medical images that have been curated via concatenated embeddings can achieve higher inferencing accuracy than a machine learning model that has instead been trained on a collection of medical images that have been curated via either lone embeddings or summed embeddings. Specifically, the present inventors conducted various experiments in which a machine learning model was trained on a collection of medical images to classify the anatomy (e.g., torso, abdomen, head) or view (e.g., frontal, rear, left, right) depicted in an inputted image. Some of those experiments involved curating the collection of medical images using lone embeddings produced by a single autoencoder or using summed embeddings produced by multiple autoencoders. Others of those experiments involved curating the collection of medical images using concatenated embeddings from multiple vision models. The present inventors found that the machine learning model trained in accordance with the concatenated embeddings achieved statistically significantly higher anatomy-classification accuracy or view-classification accuracy than when the machine learning model was instead trained in accordance with lone embeddings or summed embeddings. Indeed, the machine learning model trained in accordance with the concatenated embeddings exhibited about a 3 or 4 percentage point reduction in incorrect classifications compared to the machine learning model that was instead trained in accordance with lone embeddings or summed embeddings. Additionally, the machine learning model trained in accordance with the concatenated embeddings exhibited nearly half the proportion of inconclusive classifications compared to the machine learning model that was instead trained in accordance with lone embeddings or summed embeddings. That is, various embodiments described herein achieved a notable performance boost over existing techniques.

For at least these reasons, various embodiments described herein certainly constitute a tangible and concrete technical improvement, technical effect, or technical advantage in the field of machine learning. Accordingly, such embodiments clearly qualify as useful and practical applications of computers.

Furthermore, various embodiments described herein can control real-world tangible devices based on the disclosed teachings. For example, various embodiments described herein can manipulate a real-world medical image dataset (e.g., by removing certain images from the dataset) and train real-world deep learning neural networks using that manipulated real-world medical image dataset.

It should be appreciated that the herein figures and description provide non-limiting examples of various embodiments and are not necessarily drawn to scale.

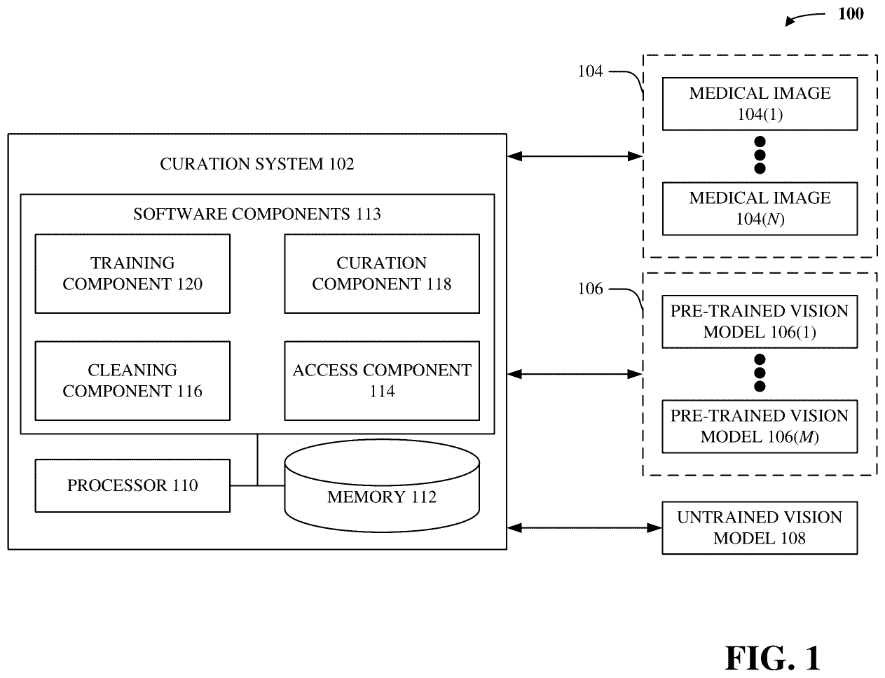

FIG. 1 illustrates a block diagram of an example, non-limiting system 100 that can facilitate training image curation via hidden feature concatenation in accordance with one or more embodiments described herein. As shown, a curation system 102 can be electronically integrated, via any suitable wired or wireless electronic connections, with a plurality of medical images 104, with a suite of pre-trained vision models 106, or with an untrained vision model 108.

In various embodiments, the plurality of medical images 104 can comprise n images, for any suitable positive integer n>1: a medical image 104(1) to a medical image 104(n). In various aspects, each of the plurality of medical images 104 can exhibit any suitable format, size, or dimensionality. As a non-limiting example, any of the plurality of medical images 104 can be an x-by-y array of pixels, for any suitable positive integers x and y. As another non-limiting example, any of the plurality of medical images 104 can be an x-by-y-by-z array of voxels, for any suitable positive integers x, y, and z. In some cases, different ones of the plurality of medical images 104 can exhibit the same or different formats, sizes, or dimensionalities as each other (e.g., some of the plurality of medical images 104 can be 256-by-256 pixel arrays, whereas others of the plurality of medical images 104 can 256-by-512 pixel arrays).

In various instances, each of the plurality of medical images 104 can be captured or otherwise generated by any suitable medical imaging scanner, equipment, or modality. As a non-limiting example, any of the plurality of medical images 104 can be captured or generated by an X-ray scanner. As another non-limiting example, any of the plurality of medical images 104 can be captured or generated by a CT scanner. As yet another non-limiting example, any of the plurality of medical images 104 can be captured or generated by an MRI scanner. As even another non-limiting example, any of the plurality of medical images 104 can be captured or generated by an ultrasound scanner. As still another non-limiting example, any of the plurality of medical images 104 can be captured or generated by a PET scanner. As another non-limiting example, any of the plurality of medical images 104 can be captured or generated by an NM scanner. In some cases, different ones of the plurality of medical images 104 can have been captured or generated by the same or different medical imaging scanners, equipment, or modalities than each other (e.g., some of the plurality of medical images 104 can have been captured or generated by X-ray scanners, whereas others of the plurality of medical images 104 can have been captured or generated by MRI scanners).

In various aspects, each of the plurality of medical images 104 can visually depict or illustrate any suitable respective anatomical structure of any suitable medical patient. As some non-limiting examples, any of the plurality of medical images 104 can depict or illustrate any suitable bodily organ of a respective medical patient, any suitable bodily tissue of a respective medical patient, any suitable body part of a respective medical patient, any suitable bodily fluid of a respective medical patient, any suitable bodily cavity of a respective medical patient, or any suitable portion thereof. In some cases, different ones of the plurality of medical images 104 can depict or illustrate the same or different types of anatomical structures as each other (e.g., some of the plurality of medical images 104 can depict patient torsos, whereas others of the plurality of medical images 104 can depict patient limbs).

In various instances, any of the plurality of medical images 104 can have undergone any suitable image reconstruction techniques, such as filtered back projection. Likewise, in various cases, any of the plurality of medical images 104 can have undergone any other suitable pre-processing or post-processing techniques, such as reorientation, denoising, or resolution enhancement.

In various aspects, each of the plurality of medical images 104 can belong to or otherwise be associated with any suitable classes or categories. As a non-limiting example, there can be any suitable number of anatomy classes or categories (e.g., each of such classes or categories corresponding to a respective anatomy, such as torso, head, arm, leg, or abdomen), and each of the plurality of medical images 104 can be considered as belonging to or otherwise being associated with a respective one of those anatomy classes or categories (e.g., can be considered as depicting an anatomical structure that belongs to one of those anatomy classes or categories). As another non-limiting example, there can be any suitable number of view classes or categories (e.g., each of such classes or categories corresponding to a respective scanning view or scanning orientation, such as frontal view, rear view, or side view), and each of the plurality of medical images 104 can be considered as belonging to or otherwise being associated with a respective one of those view classes or categories (e.g., can be considered as depicting an anatomical structure from an orientation that corresponds to one of those view classes or categories). As still another non-limiting example, there can be any suitable number of modality classes or categories (e.g., each of such classes or categories corresponding to a respective scanning modality, such as an X-ray modality, a CT modality, or a PET modality), and each of the plurality of medical images 104 can be considered as belonging to or otherwise being associated with a respective one of those modality classes or categories (e.g., can be considered as having been captured or generated by a device belonging to one of those modality classes or categories).

In various embodiments, the suite of pre-trained vision models 106 can comprise m models, for any suitable positive integer m>1: a pre-trained vision model 106(1) to a pre-trained vision model 106(m). In various aspects, each of the suite of pre-trained vision models 106 can exhibit any suitable deep learning internal architecture. Indeed, in various cases, each of the suite of pre-trained vision models 106 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As still another example, any of such input layer, one or more hidden layers, or output layer can be batch normalization layers, whose learnable or trainable parameters can be shift factors or scale factors. As even another example, any of such input layer, one or more hidden layers, or output layer can be LSTM layers, whose learnable or trainable parameters can be input-state weight matrices or hidden-state weight matrices. As yet another example, any of such input layer, one or more hidden layers, or output layer can be transformer layers, whose learnable or trainable parameters can be single-head or multi-head attention blocks or other weight matrices. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers. In various cases, different ones of the suite of pre-trained vision models 106 can exhibit the same or different internal architectures as each other.

In various aspects, each of the suite of pre-trained vision models 106 can be configured to perform any suitable respective inferencing task on inputted medical images having any suitable format, size, or dimensionality. As a non-limiting example, any of the suite of pre-trained vision models 106 can be configured to perform image classification on inputted medical images. As another non-limiting example, any of the suite of pre-trained vision models 106 can be configured to perform image segmentation on inputted medical images. As even another non-limiting example, any of the suite of pre-trained vision models 106 can be configured to perform image regression (e.g., denoising, resolution enhancement, style transfer) on inputted medical images. In various cases, different ones of the suite of pre-trained vision models 106 can be configured to perform the same or different inferencing tasks on inputted medical images as each other.

In various instances, each of the suite of pre-trained vision models 106 can have been previously trained to perform its respective inferencing task. In various aspects, such training can have been performed in a supervised fashion (e.g., internal parameters incrementally updated via backpropagation based on errors between training outputs and ground-truth annotations), in an unsupervised fashion (e.g., internal parameters incrementally updated via backpropagation based on errors computed for training outputs without ground-truth annotations), or in a reinforcement learning fashion (e.g., internal parameters incrementally updated via backpropagation based on a reward or punishment policy). In various cases, different ones of the suite of pre-trained vision models 106 can have been trained in the same or different fashion than each other.

Note that, although any of the suite of pre-trained vision models 106 can be an image autoencoder, none of the suite of pre-trained vision models 106 needs to be an image autoencoder.

In various embodiments, the untrained vision model 108 can exhibit any suitable deep learning internal architecture. Indeed, in various cases, the untrained vision model 108 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As still another example, any of such input layer, one or more hidden layers, or output layer can be batch normalization layers, whose learnable or trainable parameters can be shift factors or scale factors. As even another example, any of such input layer, one or more hidden layers, or output layer can be LSTM layers, whose learnable or trainable parameters can be input-state weight matrices or hidden-state weight matrices. As yet another example, any of such input layer, one or more hidden layers, or output layer can be transformer layers, whose learnable or trainable parameters can be single-head or multi-head attention blocks or other weight matrices. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

In any case, it can be desired to train the untrained vision model 108 on the plurality of medical images 104 so as to perform any suitable inferencing task (e.g., any suitable type of image classification, segmentation, or regression), which might be the same or different than any inferencing task performed by any of the suite of pre-trained vision models 106. In order for such training to be effective, it can be desired to first curate the plurality of medical images 104. As described herein, the curation system 102 can facilitate or otherwise perform such curation, by leveraging the suite of pre-trained vision models 106.

In various embodiments, the curation system 102 can comprise a processor 110 (e.g., computer processing unit, microprocessor) and a non-transitory computer-readable memory 112 that is operably or operatively or communicatively connected or coupled to the processor 110. The non-transitory computer-readable memory 112 can store computer-executable instructions which, upon execution by the processor 110, can cause the processor 110 or other components of the curation system 102 (e.g., access component 114, cleaning component 116, curation component 118, training component 120) to perform one or more acts. In various embodiments, the non-transitory computer-readable memory 112 can store computer-executable components (e.g., access component 114, cleaning component 116, curation component 118, training component 120), and the processor 110 can execute the computer-executable components.

In various embodiments, the curation system 102 can comprise an access component 114. In various aspects, the access component 114 can electronically access or otherwise electronically communicate in any suitable fashion with the suite of pre-trained vision models 106 or with the untrained vision model 108. Accordingly, the access component 114 can electronically transmit any suitable electronic data to the suite of pre-trained vision models 106 or to the untrained vision model 108, and the suite of pre-trained vision models 106 or the untrained vision model 108 can likewise electronically transmit any suitable electronic data to the access component 114. In some instances, the access component 114 can be considered as a proxy or conduit through which other components of the curation system 102 can interact with, communicate with, or otherwise manipulate the suite of pre-trained vision models 106 or the untrained vision model 108. In various aspects, the access component 114 can electronically access the plurality of medical images 104. That is, the access component 114 can electronically receive, electronically retrieve, or otherwise electronically obtain the plurality of medical images 104, from any suitable electronic source, database, or computerized workstation. In any case, the access component 114 can be considered as a proxy or conduit through which other components of the curation system 102 can interact with, control, or otherwise manipulate the plurality of medical images 104.

In various embodiments, the curation system 102 can comprise a cleaning component 116. In various aspects, the cleaning component 116 can, as described herein, utilize an image cleaning model to remove undesired text from the plurality of medical images 104.

In various embodiments, the curation system 102 can comprise a curation component 118. In various instances, the curation component 118 can, as described herein, curate the plurality of medical images 104 after cleaning, by creating concatenated embeddings for the plurality of medical images 104 using the suite of pre-trained vision models 106.

In various embodiments, the curation system 102 can comprise a training component 120. In various cases, the training component 120 can, as described herein, instruct any suitable computerized device to train the untrained vision model 108 using the cleaned and curated versions of the plurality of medical images 104.

Note that, in various instances, the access component 114, the cleaning component 116, the curation component 118, and the training component 120 can collectively be considered as being one or more software components 113 of the curation system 102. In various aspects, it should be appreciated that the one or more software components 113 are described primarily herein as comprising four components (e.g., the access component 114, the cleaning component 116, the curation component 118, and the training component 120) for case of explanation and illustration. However, the one or more software components 113 are not limited to being implemented as exactly such four components in every embodiment. Indeed, in some embodiments, the functionalities described herein of such four components can be combined in any suitable fashions, so as to be implemented in or by fewer than four components (e.g., in some cases, a single component can perform all of the functionalities that are described herein with respect to the access component 114, the cleaning component 116, the curation component 118, and the training component 120). In other embodiments, the functionalities described herein of such four components can instead be distributed, separated, split, or fragmented in any suitable fashions, so as to be implemented in or by more than four components (e.g., two or more components can facilitate the functionalities that are performable by the access component 114; two or more components can facilitate the functionalities that are performable by the cleaning component 116; two or more components can facilitate the functionalities that are performable by the curation component 118; two or more components can facilitate the functionalities that are performable by the training component 120).

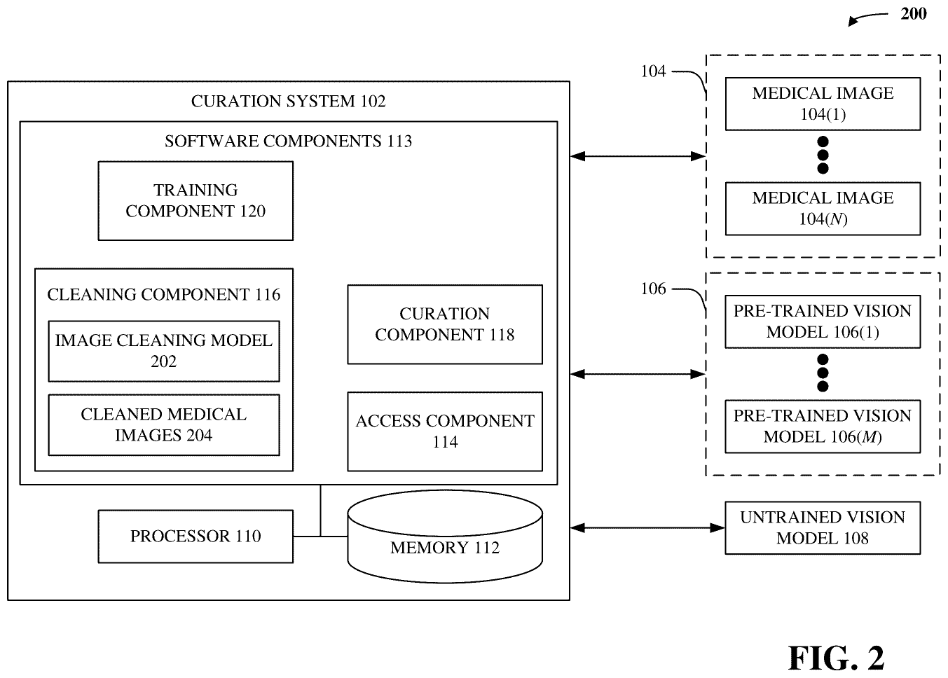

FIG. 2 illustrates a block diagram of an example, non-limiting system 200 including an image cleaning model that can facilitate training image curation via hidden feature concatenation in accordance with one or more embodiments described herein. As shown, the system 200 can, in some cases, comprise the same components as the system 100, and can further comprise an image cleaning model 202 and a plurality of cleaned medical images 204.

In various embodiments, the image cleaning model 202 can exhibit any suitable deep learning internal architecture. Indeed, in various cases, the image cleaning model 202 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As still another example, any of such input layer, one or more hidden layers, or output layer can be batch normalization layers, whose learnable or trainable parameters can be shift factors or scale factors. As even another example, any of such input layer, one or more hidden layers, or output layer can be LSTM layers, whose learnable or trainable parameters can be input-state weight matrices or hidden-state weight matrices. As yet another example, any of such input layer, one or more hidden layers, or output layer can be transformer layers, whose learnable or trainable parameters can be single-head or multi-head attention blocks or other weight matrices. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

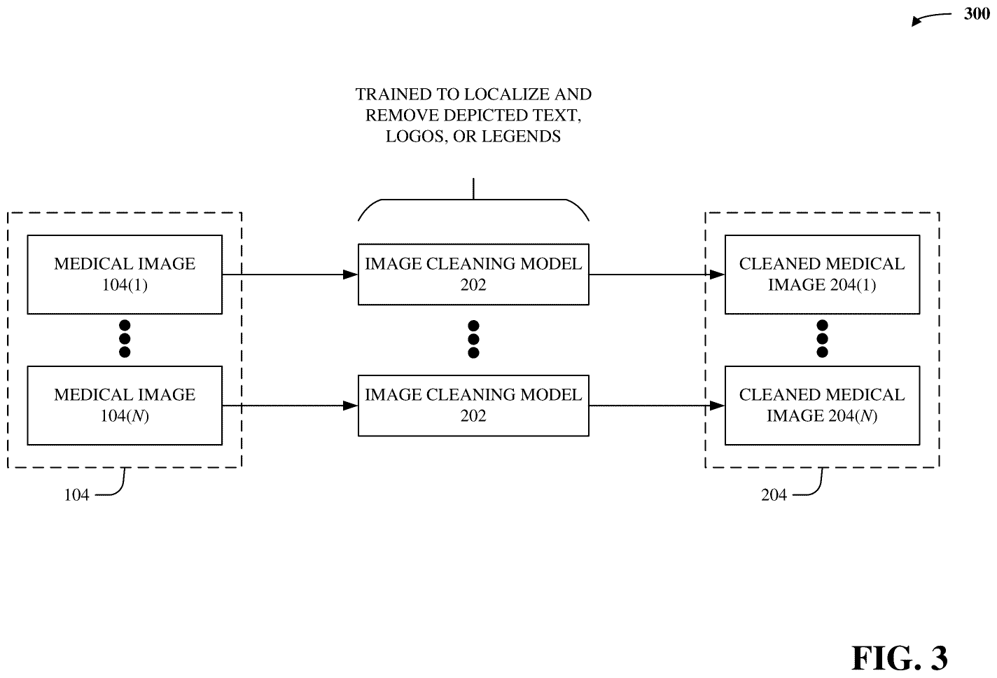

Regardless of its specific internal architecture (e.g., regardless of the specific number or order of neural network layers), the image cleaning model 202 can be configured to receive as input a medical image and to produce as output a cleaned version of that medical image. Accordingly, the cleaning component 116 can electronically leverage the image cleaning model 202, so as to convert the plurality of medical images 104 into the plurality of cleaned medical images 204. Various non-limiting aspects are described with respect to FIGS. 3-5.

FIGS. 3-5 illustrate an example non-limiting block diagram 300 and example non-limiting images 400 and 500 showing how the image cleaning model 202 can be implemented in accordance with one or more embodiments described herein.

First, consider FIG. 3. In various embodiments, the cleaning component 116 can electronically execute the image cleaning model 202 on each of the plurality of medical images 104. In various aspects, such execution can yield the plurality of cleaned medical images 204. More specifically, as mentioned above, each of the plurality of medical images 104 can depict a respective anatomical structure. However, in various instances, the anatomical structure of any given one of the plurality of medical images 104 might be partially obscured by overlaid text, such as an overlaid hospital logo, an overlaid medical imaging scanner logo, an overlaid view description, or an overlaid color-to-pixel-intensity legend. The presence of such overlaid text could potentially cause the untrained vision model 108 to learn spurious visual relationships. For instance, rather than learning to perform its inferencing task by paying attention to task-dispositive characteristics of a depicted anatomical structure, the untrained vision model 108 might instead learn to perform its inferencing task by paying attention to such overlaid text, which can be undesirable. In various cases, the image cleaning model 202 can be considered as having been trained to localize and remove any of such overlaid text from an inputted medical image. Accordingly, the cleaning component 116 can execute the image cleaning model 202 on each of the plurality of medical images 104, so as to produce as respective one of the plurality of cleaned medical images 204.

As a non-limiting example, the cleaning component 116 can execute the image cleaning model 202 on the medical image 104(1), and such execution can yield a cleaned medical image 204(1). In particular, the cleaning component 116 can feed the medical image 104(1) to an input layer of the image cleaning model 202, the medical image 104(1) can complete a forward pass through one or more hidden layers of the image cleaning model 202, and an output layer of the image cleaning model 202 can calculate or compute the cleaned medical image 204(1) based on whatever activation maps are generated by the one or more hidden layers of the image cleaning model 202 during such forward pass. In various aspects, if the medical image 104(1) depicts or illustrates any overlaid text (e.g., logos, view descriptions, legends), the image cleaning model 202 can be considered as localizing such overlaid text within the medical image 104(1). In order words, the image cleaning model 202 can be considered as determining where within the medical image 104(1) such overlaid text is located. For instance, the image cleaning model 202 can be configured to circumscribe such overlaid text with one or more bounding boxes. Based on such localization, the image cleaning model 202 can further be configured to remove, erase, delete, or otherwise eliminate such overlaid text from the medical image 104(1). For instance, the image cleaning model 202 can be configured to floor the intensity values of all pixels that are within any of its produced bounding boxes to zero (e.g., the image cleaning model 202 can black-out the pixels inside of the bounding boxes). In such case, the image cleaning model 202 can be considered as replacing the overlaid text of the medical image 104(1) with empty image space. In another instance, the image cleaning model 202 can instead be configured to in-paint the intensity values of all pixels that are within any of its produced bounding boxes. In such case, the image cleaning model 202 can be considered as inferring or predicting the true appearances of whatever portions of the anatomical structure depicted in the medical image 104(1) that are obscured by the overlaid text. In any case, the cleaned medical image 204(1) can be considered as having the same visual content as the medical image 104(1), less any overlaid text that is depicted in the medical image 104(1).

As another non-limiting example, the cleaning component 116 can execute the image cleaning model 202 on the medical image 104(n), and such execution can yield a cleaned medical image 204(n). Specifically, the cleaning component 116 can feed the medical image 104(n) to an input layer of the image cleaning model 202, the medical image 104(n) can complete a forward pass through one or more hidden layers of the image cleaning model 202, and an output layer of the image cleaning model 202 can calculate or compute the cleaned medical image 204(n) based on whatever activation maps are generated by the one or more hidden layers of the image cleaning model 202 during such forward pass. As above, if the medical image 104(n) depicts or illustrates any overlaid text, the image cleaning model 202 can be considered as localizing and removing (e.g., via blacking-out or via in-painting) such overlaid text in the medical image 104(n). So, the cleaned medical image 204(n) can be considered as having the same visual content as the medical image 104(n), less any overlaid text that is depicted in the medical image 104(n).

In various cases, the cleaned medical image 204(1) to the cleaned medical image 204(n) can be collectively considered as the plurality of cleaned medical images 204.

Note that, in various aspects, removal of overlaid text via blacking-out or in-painting can be considered as better than blurring of overlaid text. Indeed, when overlaid text is blurred in an image, the intensity values of such overlaid text are still primarily retained in the image, notwithstanding that the overlaid might be no longer legible. So, the blurred region often ends up undesirably looking like some new, additional, or phantom anatomical structure. Accordingly, although blurring might be beneficial for privacy-preservation, blurring can be considered as not beneficial for image cleaning purposes. In stark contrast, blacking-out can fully remove overlaid text from an image, such that there is no or very little risk of creating a new, additional, or phantom anatomical structure in the image. Likewise, in-painting can fully replace overlaid text with a good approximation of whatever anatomical structure is beneath such text, such that there is no or very little risk of creating a new, additional, or phantom anatomical structure in the image.

In various cases, the image cleaning model 202 can be configured to implement cropping in conjunction with text localization and removal. As a non-limiting example, the cleaned medical image 204(1) can, in some cases, have the same format, size, or dimensionality (e.g., same number of pixels) as the medical image 104(1), or can, in other cases, be cropped and thus have a smaller format, size, or dimensionality (e.g., have fewer pixels) than the medical image 104(1). As another non-limiting example, the cleaned medical image 204(n) can, in some cases, have the same format, size, or dimensionality as the medical image 104(n), or can, in other cases, be cropped and thus have a smaller format, size, or dimensionality than the medical image 104(n).

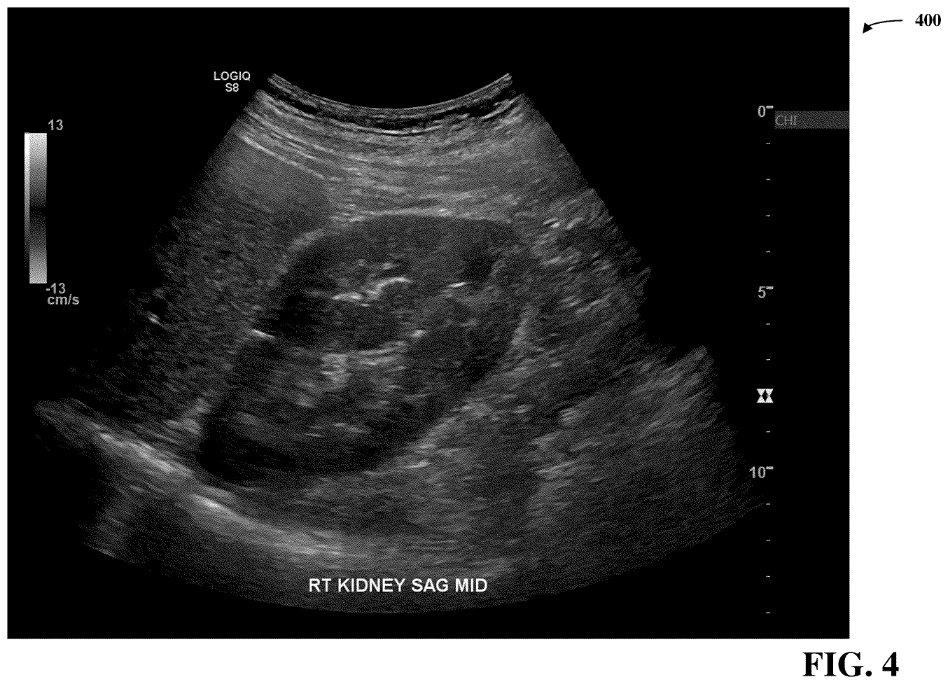

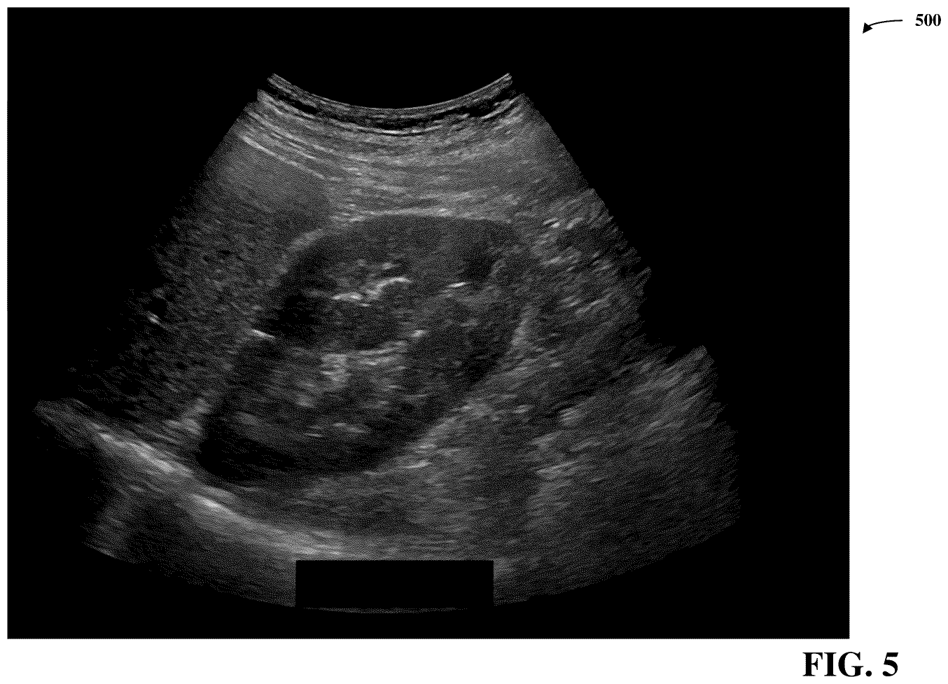

Now, consider FIGS. 4-5. FIG. 4 shows an ultrasound image 400 that includes various overlaid text. Specifically, the ultrasound image 400 includes various pixel intensity legends on its left and right edges, a view description (e.g., RT KIDNEY SAG MID) along its bottom edge, and a scanner logo (e.g., LOGIQ 58) near its top edge. FIG. 5 shows a cleaned ultrasound image 500 that has the same visual content as the ultrasound image 400, less the overlaid text. In particular, the cleaned ultrasound image 500 was obtained via the above-described localization and black-out removal technique.

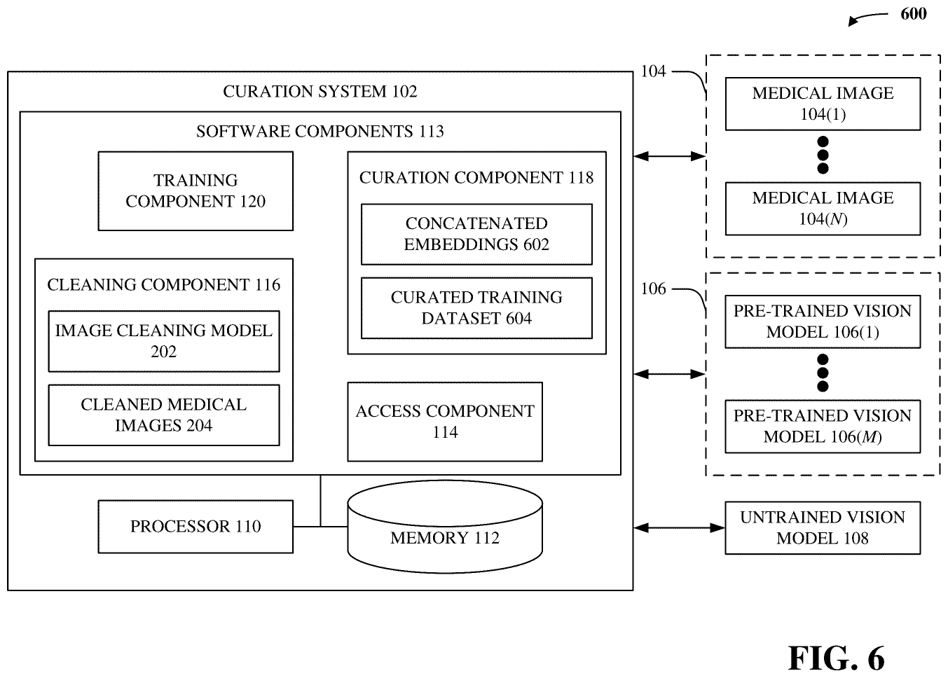

FIG. 6 illustrates a block diagram of an example, non-limiting system 600 including a plurality of concatenated embeddings and a curated training dataset that can facilitate training image curation via hidden feature concatenation in accordance with one or more embodiments described herein. As shown, the system 600 can, in some cases, comprise the same components as the system 200, and can further comprise a plurality of concatenated embeddings 602 and a curated training dataset 604.

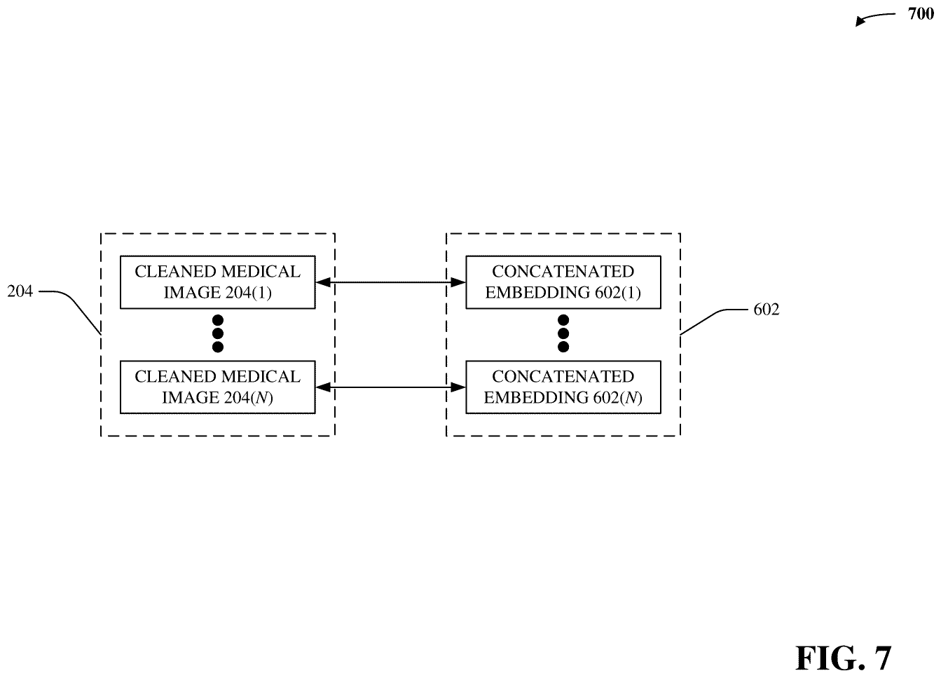

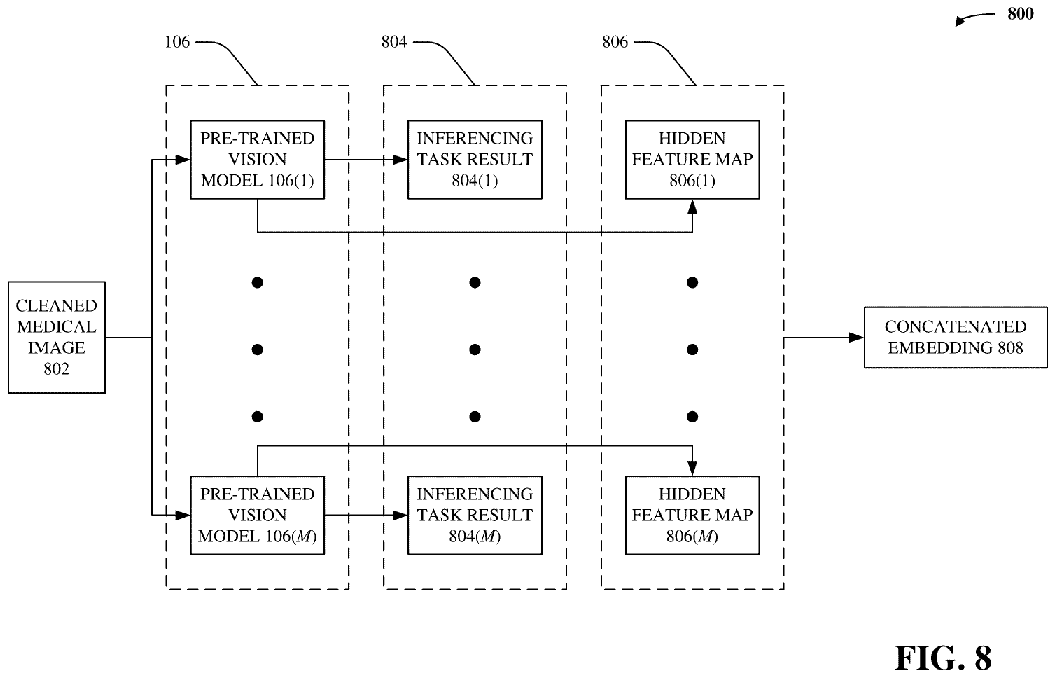

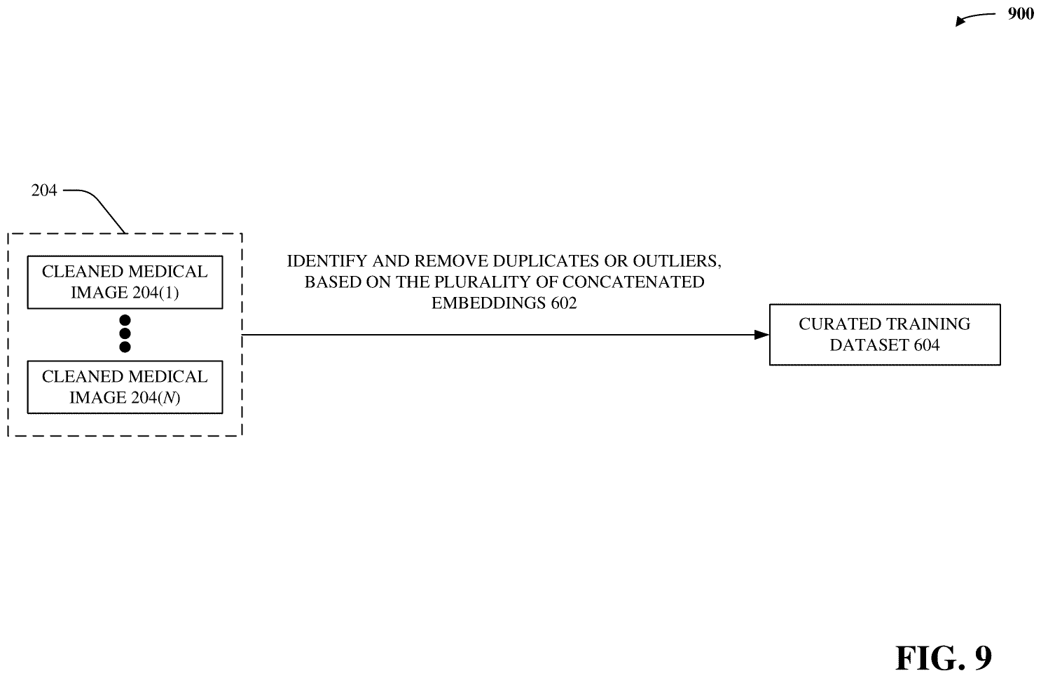

In various embodiments, the curation component 118 can electronically generate the plurality of concatenated embeddings 602, by executing each of the suite of pre-trained vision models 106 on each of the plurality of cleaned medical images 204. Various non-limiting details are described with respect to FIGS. 7-8. In various instances, the curation component 118 can organize, filter, prune, or otherwise curate the plurality of cleaned medical images 204, by leveraging the plurality of concatenated embeddings 602. Various non-limiting details are described with respect to FIGS. 9-21.

FIGS. 7-8 illustrate example, non-limiting block diagrams 700 and 800 showing how the plurality of concatenated embeddings 602 can be generated in accordance with one or more embodiments described herein.

First, consider FIG. 7. In various embodiments, as shown, the plurality of concatenated embeddings 602 can respectively correspond (e.g., in one-to-one fashion) to the plurality of cleaned medical images 204. Since the plurality of cleaned medical images 204 can comprise n images, the plurality of concatenated embeddings 602 can likewise comprise n embeddings: a concatenated embedding 602(1) to a concatenated embedding 602(n). In various aspects, each of the plurality of concatenated embeddings 602 can be considered as a concatenation of latent vector representations of a respective one of the plurality of cleaned medical images 204. In other words, each of the plurality of concatenated embeddings 602 can be a concatenation of one or more scalars, one or more vectors, one or more matrices, or one or more tensors, which concatenation numerically represents at least some substantive or visual content of a respective one of the plurality of cleaned medical images 204 in a low-dimensional fashion. That is, each of the plurality of concatenated embeddings 602 can be smaller in terms of size or dimensionality (e.g., in some cases, one or more orders of magnitude smaller) than a respective one of the plurality of cleaned medical images 204 (e.g., a cleaned medical image can comprise hundreds of thousands of pixels, whereas a concatenated embedding can comprise mere hundreds of numerical elements), but can nevertheless represent the visual content of that respective one of the plurality of cleaned medical images 204. As a non-limiting example, the concatenated embedding 602(1) can correspond to the cleaned medical image 204(1). Thus, the concatenated embedding 602(1) can be considered as a compressed or condensed latent vector that represents the visual content depicted by the cleaned medical image 204(1). As another non-limiting example, the concatenated embedding 602(n) can correspond to the cleaned medical image 204(n). So, the concatenated embedding 602(n) can be considered as a compressed or condensed latent vector that represents the visual content depicted by the cleaned medical image 204(n).

Now, consider FIG. 8. In various embodiments, the curation component 118 can electronically generate the plurality of concatenated embeddings 602, by leveraging the suite of pre-trained vision models 106. As a non-limiting example, consider a cleaned medical image 802 and a concatenated embedding 808. In various aspects, the cleaned medical image 802 can be any of the plurality of cleaned medical images 204, and the concatenated embedding 808 can be whichever one of the plurality of concatenated embeddings 602 that corresponds to the cleaned medical image 802.

In various aspects, the curation component 118 can electronically execute each of the suite of pre-trained vision models 106 on the cleaned medical image 802. In various instances, such execution can yield a plurality of inferencing task results 804.

As a non-limiting example, the curation component 118 can execute the pre-trained vision model 106(1) on the cleaned medical image 802, and such execution can yield an inferencing task result 804(1). Specifically, the curation component 118 can feed the cleaned medical image 802 to an input layer of the pre-trained vision model 106(1), the cleaned medical image 802 can complete a forward pass through one or more hidden layers of the pre-trained vision model 106(1), and an output layer of the pre-trained vision model 106(1) can calculate or compute the inferencing task result 804(1) based on whatever activation maps are generated by the one or more hidden layers of the pre-trained vision model 106(1) during such forward pass. In various cases, the format, size, or dimensionality of the inferencing task result 804(1) can depend upon the inferencing task that the pre-trained vision model 106(1) is configured to perform. For instance, the inferencing task that the pre-trained vision model 106(1) is configured to perform can be image classification. In such case, the inferencing task result 804(1) can be a classification label that the pre-trained vision model 106(1) has predicted for the cleaned medical image 802. As another instance, the inferencing task that the pre-trained vision model 106(1) is configured to perform can be image segmentation. In such case, the inferencing task result 804(1) can be a segmentation mask that the pre-trained vision model 106(1) has predicted for the cleaned medical image 802. As yet another instance, the inferencing task that the pre-trained vision model 106(1) is configured to perform can be image regression. In such case, the inferencing task result 804(1) can be a regression output (e.g., denoised image, resolution enhanced image, or other continuously-variable output) that the pre-trained vision model 106(1) has predicted for the cleaned medical image 802.

As another non-limiting example, the curation component 118 can execute the pre-trained vision model 106(m) on the cleaned medical image 802, and such execution can yield an inferencing task result 804(m). Specifically, the curation component 118 can feed the cleaned medical image 802 to an input layer of the pre-trained vision model 106(m), the cleaned medical image 802 can complete a forward pass through one or more hidden layers of the pre-trained vision model 106(m), and an output layer of the pre-trained vision model 106(m) can calculate or compute the inferencing task result 804(m) based on whatever activation maps are generated by the one or more hidden layers of the pre-trained vision model 106(m) during such forward pass. As above, the format, size, or dimensionality of the inferencing task result 804(m) can depend upon the inferencing task that the pre-trained vision model 106(m) is configured to perform (e.g., can be an inferred classification label, an inferred segmentation mask, or an inferred regression output).

In various aspects, the inferencing task result 804(1) to the inferencing task result 804(m) can be collectively considered as the plurality of inferencing task results 804.

Now, during such executions, the suite of pre-trained vision models 106 can generate a plurality of hidden feature maps 806. As a non-limiting example, while the cleaned medical image 802 is completing a forward pass through the hidden layers of the pre-trained vision model 106(1), at least one of those hidden layers can produce a hidden feature map 806(1). In other words, the hidden feature map 806(1) can be considered as being whatever array of activation values (e.g., whatever scalars, vectors, matrices, or tensors) that is generated by that at least one of the hidden layers of the pre-trained vision model 106(1). As another non-limiting example, while the cleaned medical image 802 is completing a forward pass through the hidden layers of the pre-trained vision model 106(m), at least one of those hidden layers can produce a hidden feature map 806(m). That is, the hidden feature map 806(m) can be considered as being whatever array of activation values (e.g., whatever scalars, vectors, matrices, or tensors) that is generated by that at least one of the hidden layers of the pre-trained vision model 106(m). In various aspects, the hidden feature map 806(1) to the hidden feature map 806(m) can be collectively considered as the plurality of hidden feature maps 806.

In various aspects, although none of the plurality of pre-trained vision models 106 needs to be an autoencoder, each of the plurality of hidden feature maps 806 can nevertheless be considered as a type of latent vector representation, and thus as a type of embedding, of the cleaned medical image 802. Indeed, the hidden feature map 806(1) can be considered as numerically representing (albeit in an unclear or not readily interpretable fashion) whatever visual characteristics of the cleaned medical image 802 that the pre-trained vision model 106(1) believes are dispositive or otherwise relevant with respect to whatever inferencing task that the pre-trained vision model 106(1) is configured to perform. Likewise, the hidden feature map 806(m) can be considered as numerically representing (albeit in an unclear or not readily interpretable fashion) whatever visual characteristics of the cleaned medical image 802 that the pre-trained vision model 106(m) believes are dispositive or otherwise relevant with respect to whatever inferencing task that the pre-trained vision model 106(m) is configured to perform. Accordingly, different ones of the plurality of hidden feature maps 806 can be considered as representing or capturing different or unique combinations of visual characteristics of the cleaned medical image 802. In fact, different ones of the plurality of hidden feature maps 806 can have the same or different formats, sizes, or dimensionalities as each other (e.g., some of the plurality of hidden feature maps 806 can be 15-element row vectors; others of the plurality of hidden feature maps 806 can be 30-element row vectors; yet others of the plurality of hidden feature maps 806 can be two-dimensional matrices; still others of the plurality of hidden feature maps 806 can be higher-dimensional tensors).

In various instances, the curation component 118 can electronically concatenate (not sum) the plurality of hidden feature maps 806 together. Such concatenation can be referred to as the concatenated embedding 808. Thus, the concatenated embedding 808 can be considered as representing more of the visual content of the cleaned medical image 802 than any single one of the plurality of hidden feature maps 806 could represent in isolation.

Note that, in various cases, it can be possible that the suite of pre-trained vision models 106 are configured to operate on differently sized images than each other. If that is the case, it should be understood that the curation component 118 can apply any suitable upsampling, downsampling, or padding techniques to the cleaned medical image 802 as appropriate, so as to cause the cleaned medical image 802 to be correctly-sized for each respective one of the suite of pre-trained vision models 106.

Furthermore, note that, in various aspects, the curation component 118 can extract activations consistently from the suite of pre-trained vision models 106 across all of the plurality of cleaned medical images 204 (e.g., the curation component 118 can extract activations from a jₗ-th hidden layer of the pre-trained vision model 106(1) for each of the plurality of cleaned medical images 204, for any suitable positive integer jₗ; the curation component 118 can extract activations from a jₘ-th hidden layer of the pre-trained vision model 106(m) for each of the plurality of cleaned medical images 204, for any suitable positive integer jₘ). Thus, each of the plurality of concatenated embeddings 602 can be considered as having the same format, size, or dimensionality as each other.

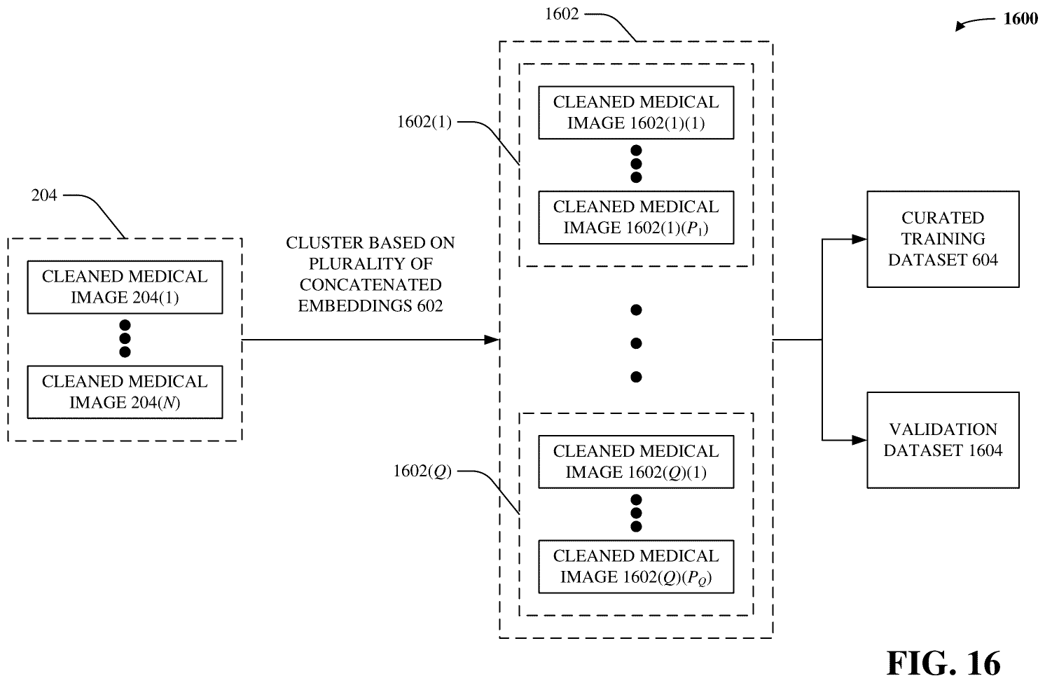

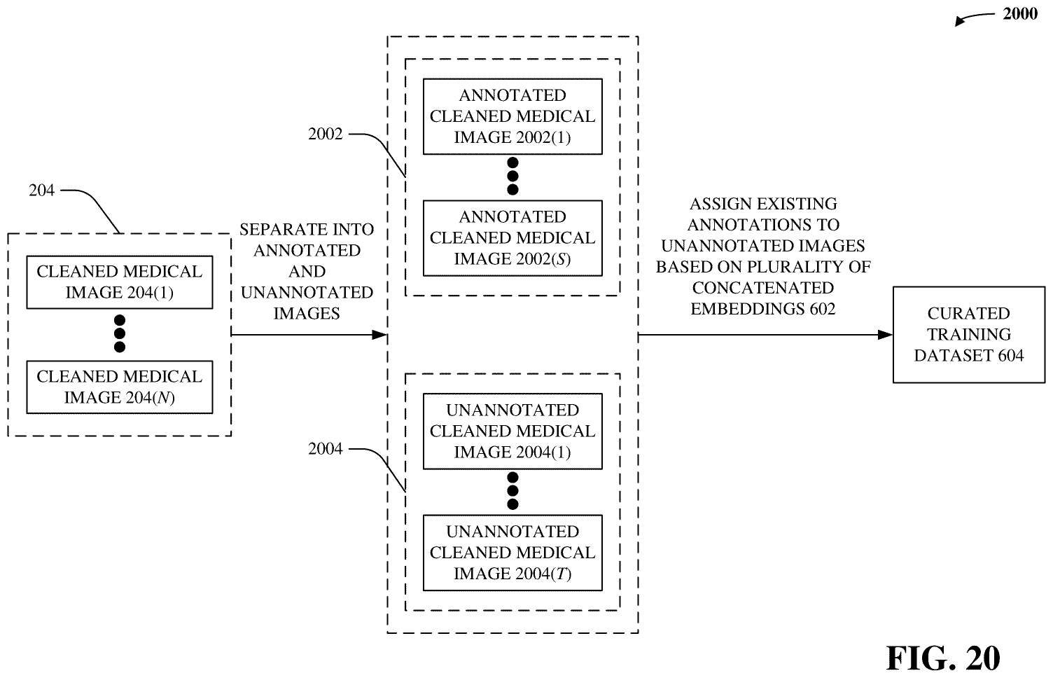

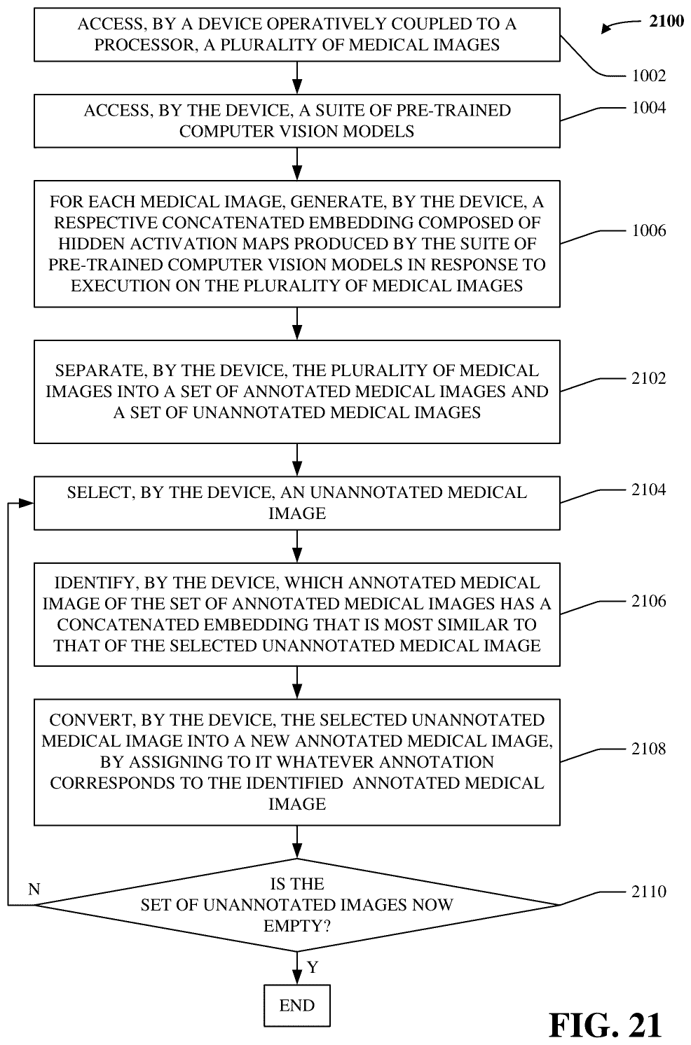

In any case, the curation component 118 can electronically generate a respective concatenated embedding for each of the plurality of cleaned medical images 204, thereby yielding the plurality of concatenated embeddings 602. In various aspects, the curation component 118 can electronically leverage the plurality of concatenated embeddings 602, so as to convert the plurality of cleaned medical images 204 into the curated training dataset 604. In some cases, the curation component 118 can facilitate this conversion by using the plurality of concatenated embeddings 602 to remove duplicated images or outlying images from the plurality of cleaned medical images 204. Various non-limiting details are described with respect to FIGS. 9-15. In other cases, the curation component 118 can facilitate this conversion by using the plurality of concatenated embeddings 602 to cluster the plurality of cleaned medical images 204 and form substantively-proportional training and validation datasets based on those clusters. Various non-limiting details are described with respect to FIGS. 16-19. In even other cases, the curation component 118 can facilitate this conversion by using the plurality of concatenated embeddings 602 to assign ground-truth annotations among the plurality of cleaned medical images 204. Various non-limiting details are described with respect to FIGS. 20-21. In any case, the training component 120 can electronically train the untrained vision model 108 on the curated training dataset 604. In some instances, this training can be performed in a supervised fashion (e.g., if the plurality of cleaned medical images 204 are annotated). In other instances, this training can be performed in any other suitable fashion, such as unsupervised fashion or reinforcement learning fashion.

FIGS. 9-15 illustrate an example non-limiting block diagram 900, example non-limiting computer-implemented methods 1000 and 1300, and example non-limiting scanned images showing how the curated training dataset 604 can be generated via duplicate or outlier removal in accordance with one or more embodiments described herein.

First, consider FIG. 9. In various embodiments, the curation component 118 can electronically identify and remove from the plurality of cleaned medical images 204 any duplicated images, nearly-duplicated images, or outlying images. In various aspects, whatever remains of the plurality of cleaned medical images 204 after such removal can be considered or otherwise referred to as the curated training dataset 604. In various instances, the curation component 118 can facilitate such identification and removal, by comparing the plurality of concatenated embeddings 602 to each other.

As a non-limiting example, the curation component 118 can iterate through each of the plurality of cleaned medical images 204 as follows. For any given cleaned medical image, the curation component 118 can compute a respective similarity score between the concatenated embedding of that given cleaned medical image and the concatenated embedding of every remaining cleaned medical image in the plurality of cleaned medical images 204. In some cases, such similarity scores can be equal to or otherwise based on cosine similarity computations (e.g., a similarity score between the cleaned medical image 204(1) and the cleaned medical image 204(n) can be equal to or otherwise based on the cosine similarity between the concatenated embedding 602(1) and the concatenated embedding 602(n)). In such scenario, higher similarity score values (e.g., closer to 1) can be considered as indicating more similarity, whereas lower similarity score values (e.g., closer to 0) can instead be considered as indicating less similarity. In other cases, such similarity scores can be equal to or otherwise based on Euclidean distance computations (e.g., a similarity score between the cleaned medical image 204(1) and the cleaned medical image 204(n) can be equal to or otherwise based on the Euclidean distance between the concatenated embedding 602(1) and the concatenated embedding 602(n)). In such scenario, higher similarity score values can be considered as indicating less similarity (e.g., more separation distance), whereas lower similarity score values (e.g., closer to 0) can instead be considered as indicating more similarity (e.g., less separation distance). Note that, in some instances, similarity scores can be equal to or otherwise based on reciprocals of Euclidean distances, such that higher similarity score values can be considered as indicating more similarity (e.g., less separation distance in the denominator), whereas lower similarity score values (e.g., closer to 0) can instead be considered as indicating less similarity (e.g., more separation distance in denominator). In any case, the curation component 118 can electronically remove or discard from the plurality of cleaned medical images 204 whichever of those remaining cleaned medical images have similarity scores that satisfy any suitable similarity threshold (e.g., that indicate more than a threshold amount of similarity). After all, whichever of those remaining cleaned medical images have similarity scores that satisfy any suitable similarity threshold can be considered as being identical or nearly identical to the given cleaned medical image. By performing this procedure for each cleaned medical image that remains in the plurality of cleaned medical images 204, all but one of each group of duplicated or nearly-duplicated images in the plurality of cleaned medical images 204 can be removed. Accordingly, whatever is left of the plurality of cleaned medical images 204 can be considered as being the curated training dataset 604. In some cases, the curation component 118 can perform this similarity computation and removal on a dataset-wide basis (e.g., for each given cleaned medical image, can compute a respective similarity score between that given cleaned medical image and each remaining cleaned medical image). In other cases, however, the curation component 118 can perform this similarity computation and removal on any suitable class-wise basis (e.g., for each given cleaned medical image, can compute a respective similarity score between that given cleaned medical image and each remaining cleaned medical image that belongs to a same anatomy class, view class, or modality class as the given cleaned medical image).

As another non-limiting example, the curation component 118 can iterate through each of the plurality of cleaned medical images 204 as follows. For any given cleaned medical image, the curation component 118 can compute a respective similarity score (e.g., via cosine similarity, via Euclidean distance) between the concatenated embedding of that given cleaned medical image and the concatenated embedding of every remaining cleaned medical image in the plurality of cleaned medical images 204. Moreover, the curation component 118 can average all of such similarity scores together, thereby yielding a mean pairwise similarity score for the given cleaned medical image. In this way, the curation component 118 can compute a respective mean pairwise similarity score for each of the plurality of cleaned medical images 204. In various instances, the curation component 118 can electronically remove or discard from the plurality of cleaned medical images 204 whichever cleaned medical images that have mean pairwise similarity scores that fail to satisfy any suitable similarity threshold (e.g., that indicate less than a threshold amount of similarity). Alternatively, the curation component 118 can electronically remove or discard from the plurality of cleaned medical images 204 whichever v cleaned medical images that have the lowest mean pairwise similarity scores, for any suitable positive integer v. After all, whichever cleaned medical images have insufficient or otherwise low mean pairwise similarity scores can be considered as being significantly different from the rest of the plurality of cleaned medical images 204. By performing this procedure, extreme outlying images in the plurality of cleaned medical images 204 can be removed. Accordingly, whatever is left of the plurality of cleaned medical images 204 can be considered as being the curated training dataset 604.

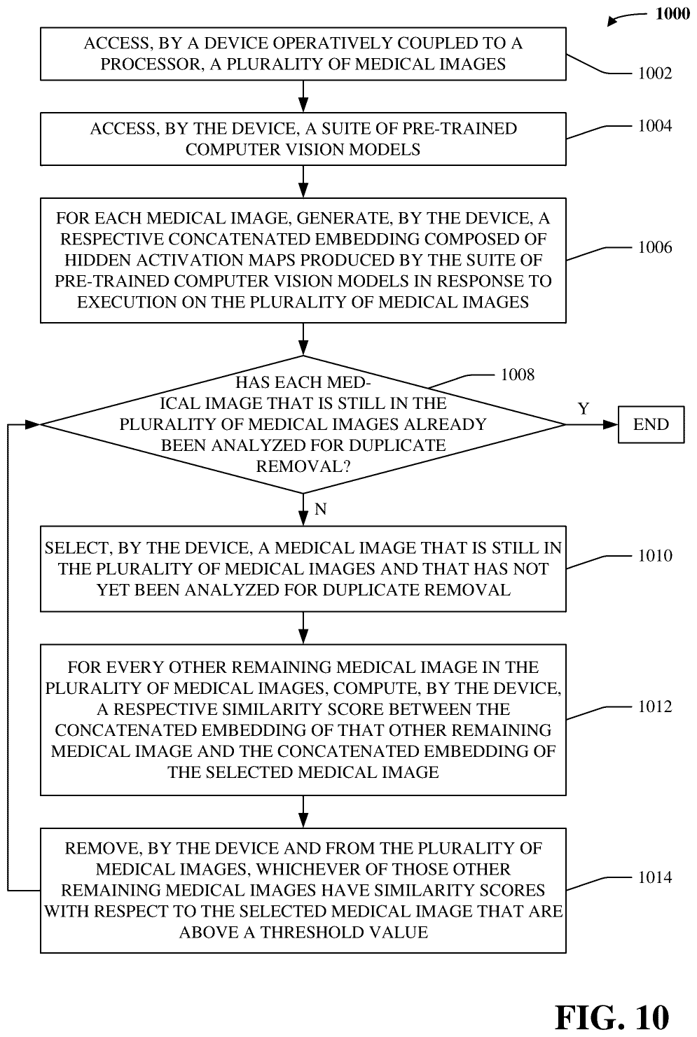

FIG. 10 illustrates a computer-implemented method 1000 that can facilitate dataset curation via duplicate removal in accordance with one or more embodiments described herein.

In various embodiments, act 1002 can include accessing, by a device (e.g., via 114) operatively coupled to a processor (e.g., 110), a plurality of medical images (e.g., 104, or equivalently 204).

In various aspects, act 1004 can include accessing, by the device (e.g., via 114), a suite of pre-trained computer vision models (e.g., 106).

In various instances, act 1006 can include generating, by the device (e.g., via 118) and for each medical image (e.g., 802), a respective concatenated embedding (e.g., 808, one of 602) composed of hidden activation maps (e.g., 806) produced by the suite of pre-trained computer vision models in response to execution on the plurality of medical images.

In various cases, act 1008 can include determining, by the device (e.g., via 118), whether each medical image that is still in the plurality of medical images has already been analyzed for duplicate removal. If so, the computer-implemented method 1000 can end. If not, the computer-implemented method 1000 can proceed to act 1010.

In various aspects, act 1010 can include selecting, by the device (e.g., via 118), a medical image that is still in the plurality of medical images and that has not yet been analyzed for duplicate removal.

In various instances, act 1012 can include computing, by the device (e.g., via 118) and for every other remaining medical image in the plurality of medical images, a respective similarity score (e.g., cosine similarity) between the concatenated embedding of that remaining medical image and the concatenated embedding of the selected medical image.

In various cases, act 1014 can include removing, by the device (e.g., via 118) and from the plurality of medical images, whichever of those other remaining medical images have similarity scores with respect to the selected medical image that are above a threshold value. In various aspects, the computer-implemented method 1000 can proceed back to act 1008.

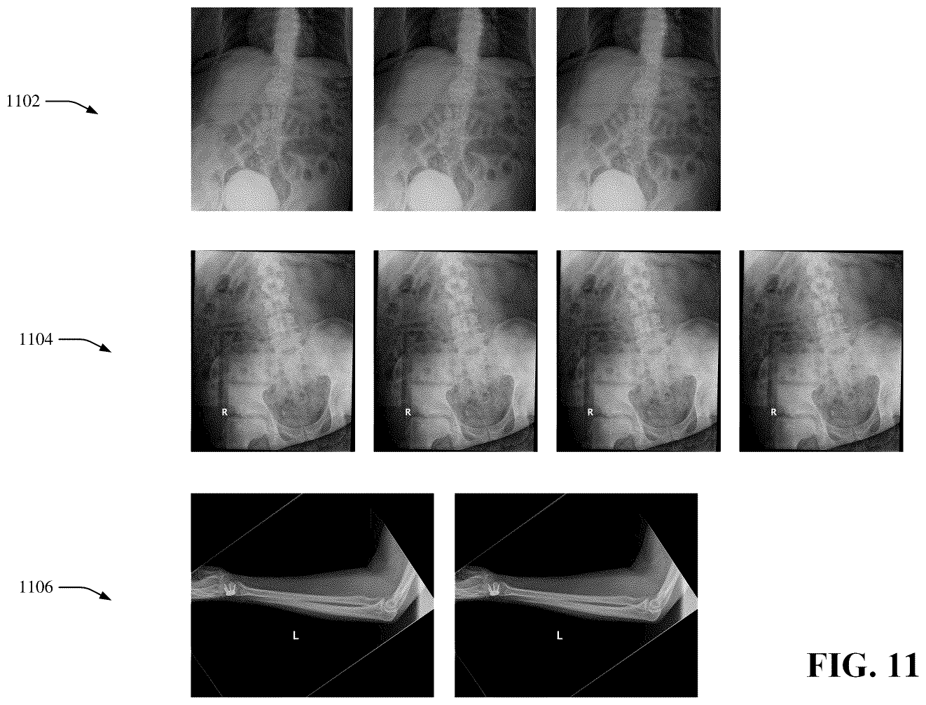

FIG. 11 depicts various real-world examples of X-ray scanned images that were eliminated from a real-world medical image dataset via duplicate removal as described above.

Numeral 1102 shows three identical X-ray scanned images that were erroneously included in the real-world medical image dataset and that were identified via various embodiments described herein. Thus, two of those three identical X-ray scanned images were subsequently removed from the real-world medical image dataset.

Likewise, numeral 1104 shows four identical X-ray scanned images that were erroneously included in the real-world medical image dataset and that were identified via various embodiments described herein. Thus, three of those four identical X-ray scanned images were subsequently removed from the real-world medical image dataset.

Similarly, numeral 1106 shows two identical X-ray scanned images that were erroneously included in the real-world medical image dataset and that were identified via various embodiments described herein. Thus, one of those two identical X-ray scanned images was subsequently removed from the real-world medical image dataset.

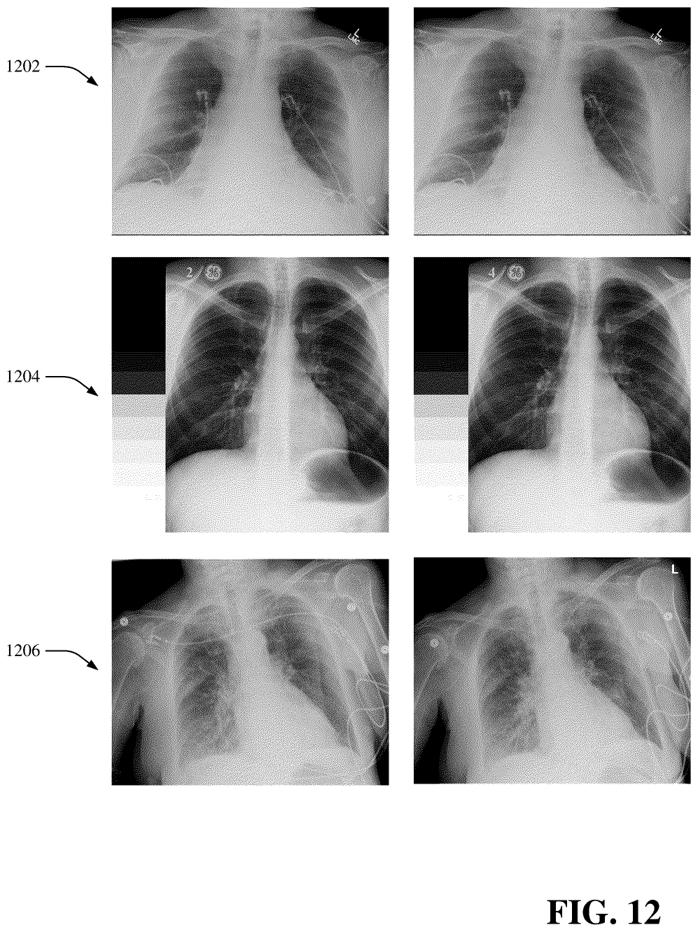

FIG. 12 depicts various real-world examples of X-ray scanned images that were eliminated from a real-world medical image dataset via near-duplicate removal as described above.

Numeral 1202 shows two nearly identical X-ray scanned images (e.g., cosine similarity of 0.999996) that were erroneously included in the real-world medical image dataset and that were identified via various embodiments described herein. Thus, one of those two nearly identical X-ray scanned images was subsequently removed from the real-world medical image dataset.

Numeral 1204 shows two nearly identical X-ray scanned images (e.g., cosine similarity of 0.991441) that were erroneously included in the real-world medical image dataset and that were identified via various embodiments described herein (e.g., only visual difference is top-left text). Thus, one of those two identical X-ray scanned images was subsequently removed from the real-world medical image dataset.

Numeral 1206 shows two nearly identical X-ray scanned images (e.g., cosine similarity of 0.942362) that were erroneously included in the real-world medical image dataset and that were identified via various embodiments described herein (e.g., minor visual differences include different wire placement). Thus, one of those two identical X-ray scanned images was subsequently removed from the real-world medical image dataset.

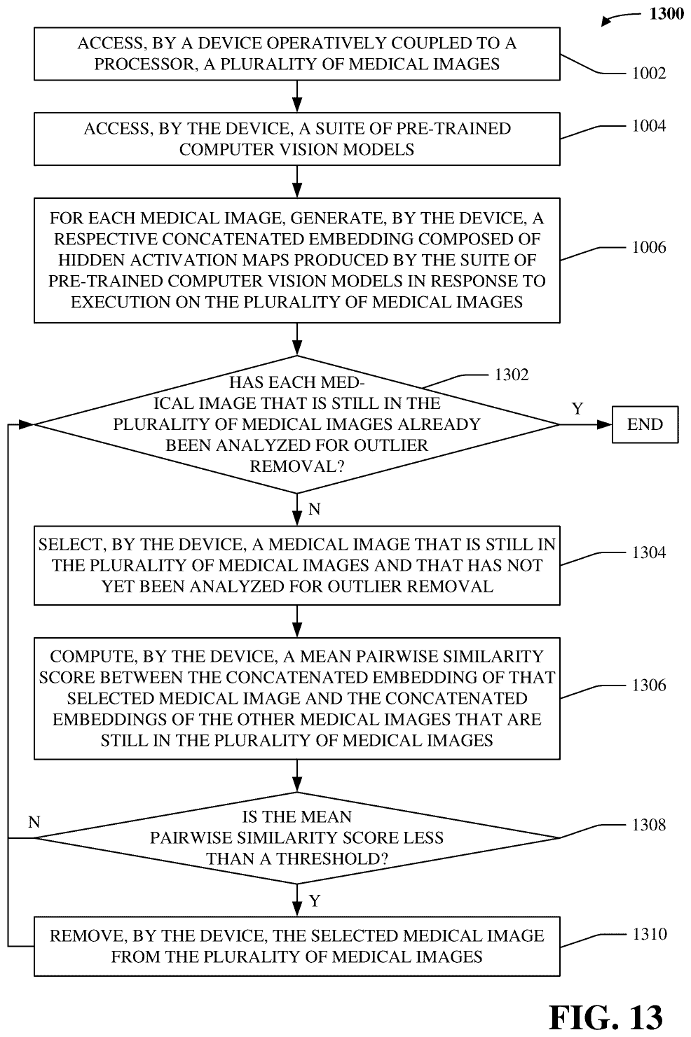

FIG. 13 illustrates a computer-implemented method 1300 that can facilitate dataset curation via outlier removal in accordance with one or more embodiments described herein.

In various embodiments, acts 1002, 1004, and 1006 can be as described above.

In various aspects, act 1302 can include determining, by the device (e.g., via 118), whether each medical image that is still in the plurality of medical images has already been analyzed for outlier removal. If so, the computer-implemented method 1300 can end. If not, the computer-implemented method 1300 can proceed to act 1304.

In various aspects, act 1304 can include selecting, by the device (e.g., via 118), a medical image that is still in the plurality of medical images and that has not yet been analyzed for outlier removal.

In various instances, act 1306 can include computing, by the device (e.g., via 118), a mean pairwise similarity score (e.g., mean pairwise cosine similarity) between the concatenated embedding of that selected medical image and the concatenated embeddings of the other medical images that are still in the plurality of medical images (e.g., can optionally be on a class-wise basis).

In various cases, act 1308 can include determining, by the device (e.g., via 118), whether the mean pairwise similarity score of the selected medical image is less than a threshold. If not, the computer-implemented method 1300 can proceed back to act 1302. If so, the computer-implemented method 1300 can proceed to act 1310.

In various aspects, act 1310 can include removing, by the device (e.g., via 118) and from the plurality of medical images, the selected medical image. In various cases, the computer-implemented method 1300 can proceed back to act 1302.

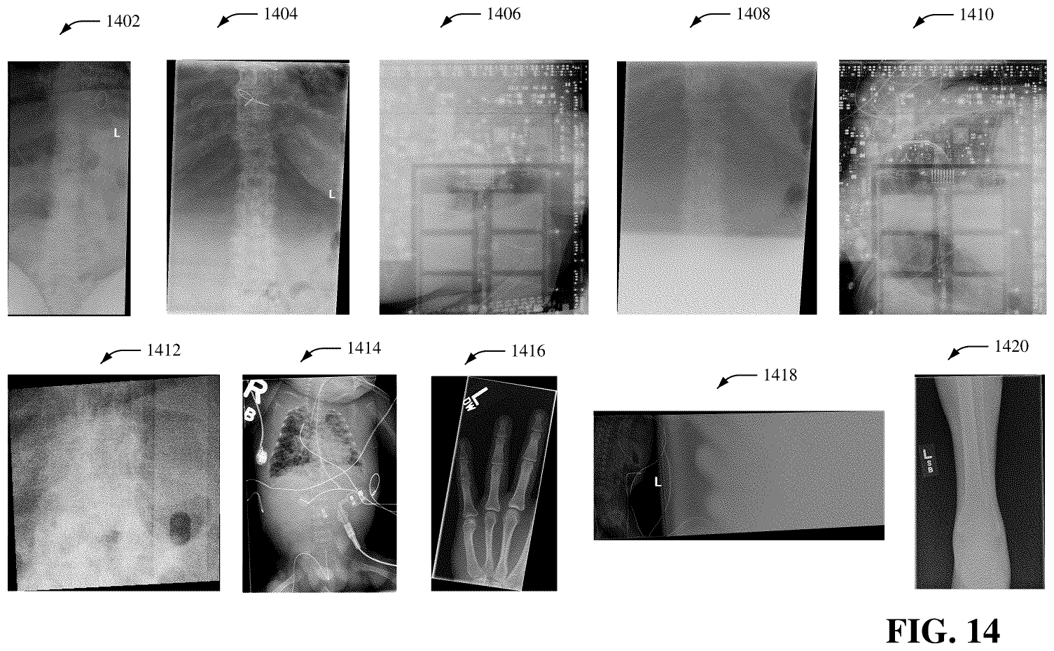

FIG. 14 depicts various real-world examples of X-ray scanned images that were eliminated from a real-world medical image dataset via outlier removal as described above.

Numerals 1402, 1404, 1408, and 1412 show outlying medical images that were assigned to a “spine” anatomy class. Numerals 1406 and 1410 show outlying medical images belonging to a “chest” anatomy class. Numerals 1414 and 1418 show outlying medical images belonging to an “abdomen” anatomy class. Numeral 1416 shows an outlying medical image belonging to a “hand” anatomy class. Numeral 1420 shows an outlying medical image belonging to an “ankle” anatomy class.

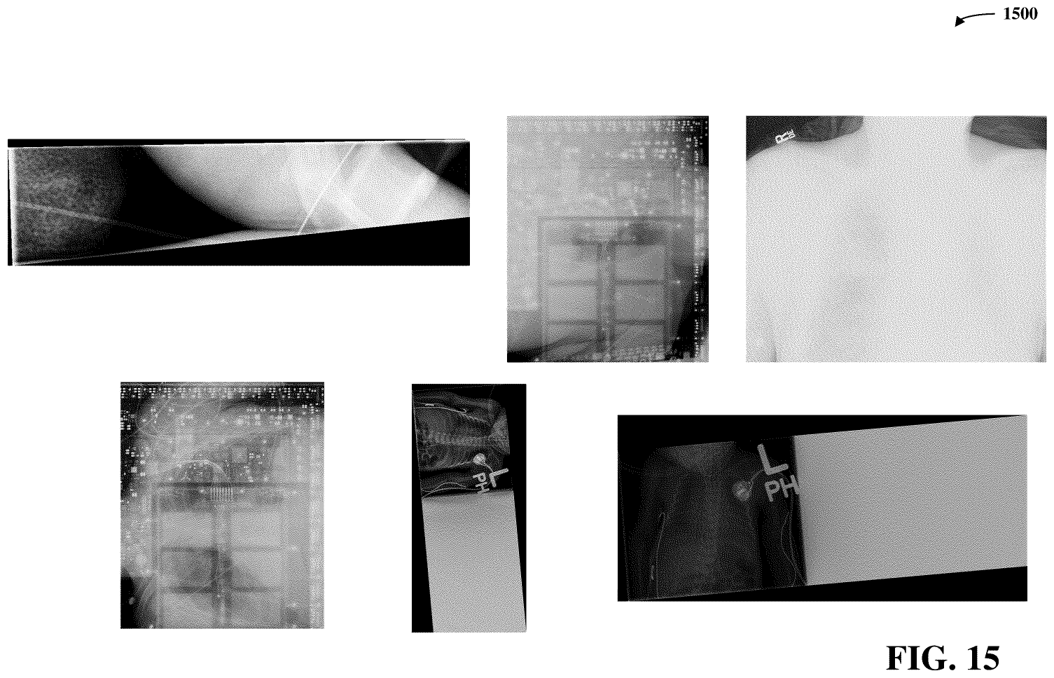

FIG. 15 depicts various real-world examples 1500 of X-ray scanned images that were eliminated from a real-world medical image dataset via class-wise outlier removal as described above. In particular, the X-ray scanned images of FIG. 15 were identified as outlying images when mean pairwise similarity scores were computed only for images belonging to the “chest” category of the real-world medical image dataset.

FIGS. 16-19 illustrate an example non-limiting block diagram 1600, an example non-limiting computer-implemented method 1700, and example non-limiting scanned images showing how the curated training dataset 604 can be generated via cluster-based splitting in accordance with one or more embodiments described herein.

First, consider FIG. 16. In various embodiments, the curation component 118 can electronically separate the plurality of cleaned medical images 204 into a plurality of clusters 1602, by applying any suitable clustering algorithm to the plurality of concatenated embeddings 602. As a non-limiting example, the curation component 118 can apply a hierarchical clustering algorithm to the plurality of concatenated embeddings 602. As another non-limiting example, the curation component 118 can apply a density-based spatial clustering of applications with noise (DBSCAN) clustering algorithm to the plurality of concatenated embeddings 602. As yet another non-limiting example, the curation component 118 can apply a mean shift clustering algorithm to the plurality of concatenated embeddings 602. As even another non-limiting example, the curation component 118 can apply a Gaussian mixture modeling clustering algorithm to the plurality of concatenated embeddings 602. As still another non-limiting example, the curation component 118 can apply an affinity propagation clustering algorithm to the plurality of concatenated embeddings 602. As another non-limiting example, the curation component 118 can apply an ordering points to identify the clustering structure (OPTICS) clustering algorithm to the plurality of concatenated embeddings 602. In any case, the plurality of clusters 1602 can comprise q clusters, for any suitable positive integer q>1: a cluster 1602(1) to a cluster 1602(q). In various aspects, each of the plurality of clusters 1602 can comprise any suitable number of cleaned medical images from the plurality of cleaned medical images 204. For instance, the cluster 1602(1) can comprise a total of pₗ cleaned medical images, for any suitable positive integer pₗ: a cleaned medical image 1602(1)(1) to a cleaned medical image 1602(1)(pₗ). In another instance, the cluster 1602(q) can comprise a total of p_{q} cleaned medical images, for any suitable positive integer p_{q}: a cleaned medical image 1602(q)(1) to a cleaned medical image 1602(q)(p_{q}). Note that the plurality of clusters 1602 can be disjoint or non-overlapping with each other, such that

$${\sum }_{i = 1}^{q} {p}_{i} = n .$$

In any case, each of the plurality of clusters 1602 can be considered as containing cleaned medical images that are substantively or visually related to each other (e.g., one cluster might contain cleaned medical images that all belong to a particular imaging modality class, that all belong to a particular anatomy class, or that all belong to a particular view class; a different cluster might contain cleaned medical images that all belong to some other imaging modality class, that all belong to some other anatomy class, or that all belong to some other view class).

In various aspects, the curation component 118 can proportionally split each of the plurality of clusters 1602 into the curated training dataset 604, which the training component 120 can use to train the untrained vision model 108, and into a validation dataset 1604, which the training component 120 can instead use to validate the untrained vision model 108 after such training. As a non-limiting example, for any suitable desired or specified percentage value, the curation component 118 can cause the curated training dataset 604 to contain that desired or specified percentage of each of the plurality of clusters 1602. Accordingly, the remainders of the plurality of clusters 1602 can be considered as collectively making the validation dataset 1604. As a non-limiting example, suppose that the desired or specified percentage value is 63%. In such case, the curation component 118 can randomly select 63% of each of the plurality of clusters 1602, and such selected cleaned medical images can be considered as making up the curated training dataset 604. Thus, the remaining 37% of each of the plurality of clusters 1602 can be considered as collectively making up the validation dataset 1604. In some cases, the curation component 118 can perform this clustering on a dataset-wide basis (e.g., can cluster at once the entirety of the plurality of cleaned medical images 204). In other cases, however, the curation component 118 can perform this clustering on any suitable class-wise basis (e.g., can cluster at once not the entirety of the plurality of cleaned medical images 204, but instead each distinct anatomy class, modality class, or view class of the plurality of cleaned medical images 204). In any case, the herein-described clustering can be considered as an intelligent way of splitting the plurality of cleaned medical images 204 so as to ensure substantive proportionality between training and validation datasets.

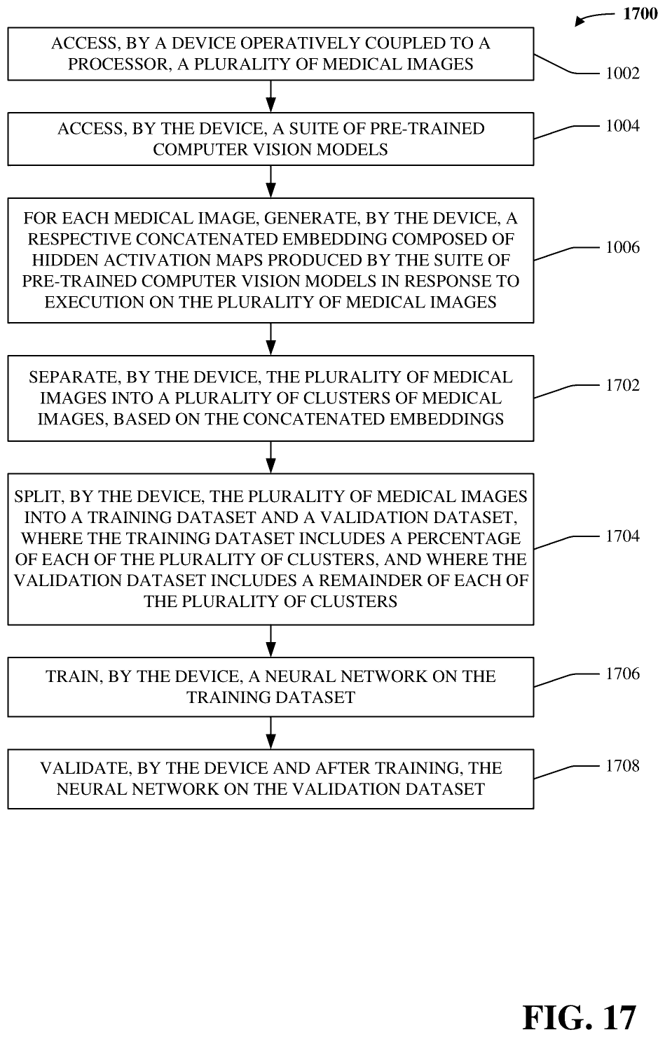

FIG. 17 illustrates a computer-implemented method 1700 that can facilitate dataset curation via cluster-based splitting in accordance with one or more embodiments described herein.

In various embodiments, acts 1002, 1004, and 1006 can be as described above.

In various aspects, act 1702 can include separating, by the device (e.g., via 118), the plurality of medical images into a plurality of clusters of medical images (e.g., 1602), based on the concatenated embeddings.

In various instances, act 1704 can include splitting, by the device (e.g., via 118), the plurality of medical images into a training dataset (e.g., 604) and a validation dataset (e.g., 1604), where the training dataset can include a common or universal percentage of each of the plurality of clusters, and where the validation dataset can include a remainder of each of the plurality of clusters.

In various cases, act 1706 can include training, by the device (e.g., via 120), a neural network (e.g., 108) on the training dataset.

In various aspects, act 1708 can include validating, by the device (e.g., via 120) and after such training, the neural network on the validation dataset (e.g., can include determining whether or not the neural network has achieved a satisfactory level of inferencing accuracy).

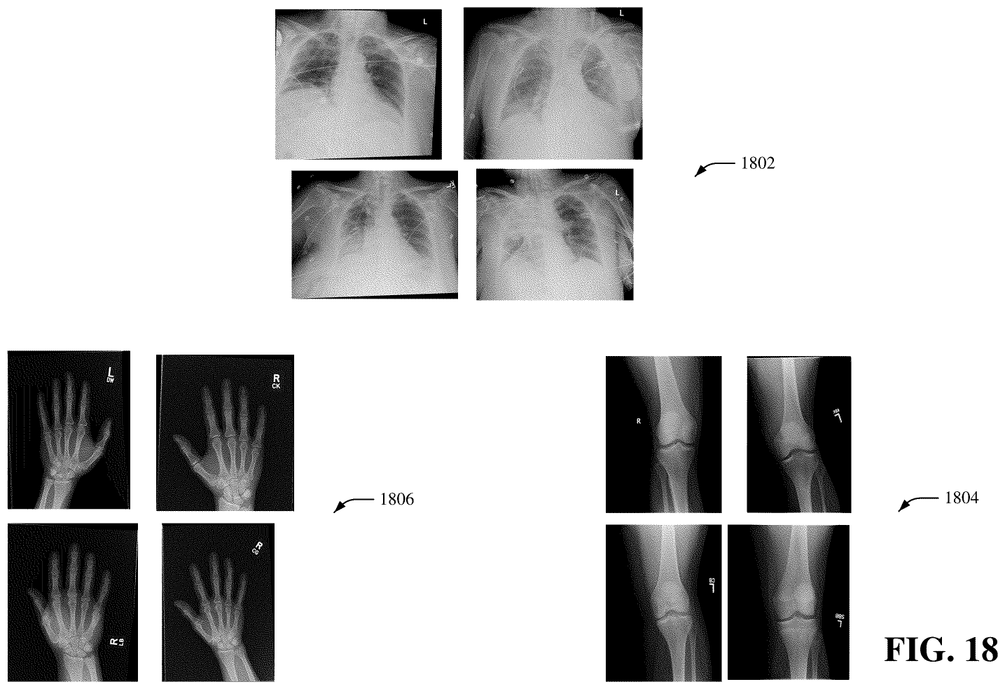

FIG. 18 depicts various real-world examples of X-ray scanned images in a real-world medical image dataset that was separated into training and validation datasets via cluster-based splitting as described above.

Numeral 1802 shows part of a first cluster that was identified in the real-world medical image dataset. A given percentage of the first cluster was placed into a training dataset, whereas a remainder of the first cluster was placed into a validation dataset.

Numeral 1804 shows part of a second cluster that was identified in the real-world medical image dataset. As above, the given percentage of the second cluster was placed into the training dataset, whereas the remainder of the second cluster was placed into the validation dataset.

Numeral 1806 shows part of a third cluster that was identified in the real-world medical image dataset. As above, the given percentage of the third cluster was placed into the training dataset, whereas the remainder of the third cluster was placed into the validation dataset.

Such cluster-based splitting helped to ensure that the validation dataset was substantively proportional to (e.g., not substantively skewed with respect to) the training dataset.

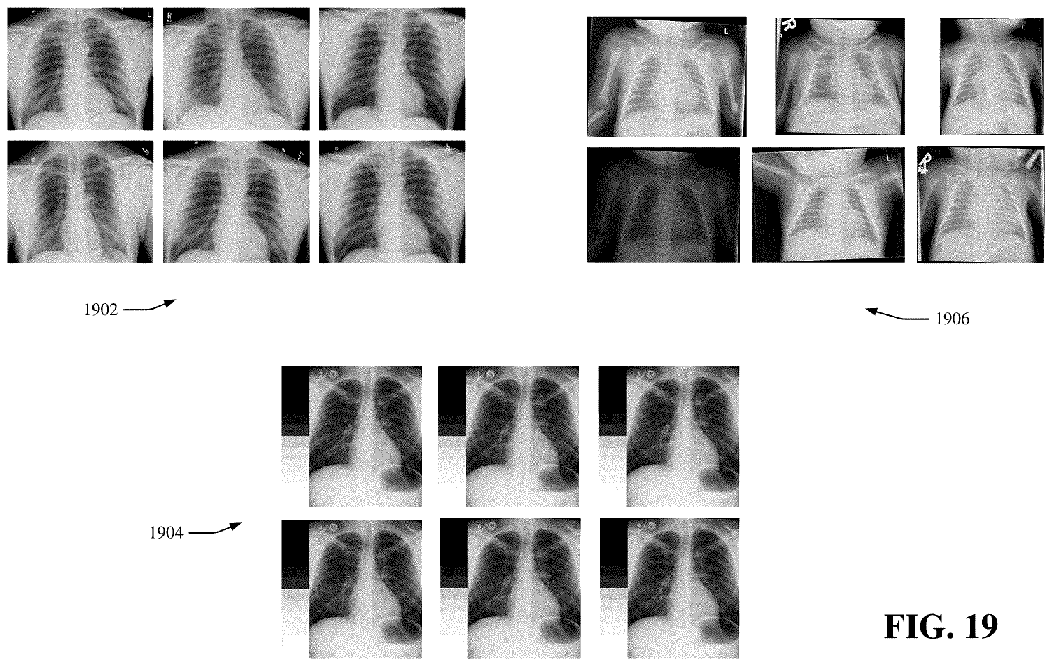

FIG. 19 depicts various real-world examples of X-ray scanned images of a real-world medical image dataset was separated into a training dataset and a validation dataset via class-wise cluster-based splitting as described above.

In particular, the herein-described clustering and splitting was performed for all images in the real-world medical image dataset that belonged to a “chest” anatomy category.

Numeral 1902 shows part of a first cluster of chest images that was identified in the real-world medical image dataset. A desired percentage of the first cluster was placed into the training dataset, whereas the remainder of the first cluster was placed into the validation dataset.

Numeral 1904 shows part of a second cluster of chest images that was identified in the real-world medical image dataset. As above, the desired percentage of the second cluster was placed into the training dataset, whereas the remainder of the second cluster was placed into the validation dataset.

Numeral 1906 shows part of a third cluster of chest images that was identified in the real-world medical image dataset. The desired percentage of the third cluster was placed into the training dataset, whereas the remainder of the third cluster was placed into the validation dataset.

As above, such cluster-based splitting helped to ensure that the validation dataset was substantively proportional to (e.g., not substantively skewed with respect to) the training dataset.

FIGS. 20-21 illustrate an example non-limiting block diagram 2000 and an example non-limiting computer-implemented method 2100 showing how the curated training dataset 604 can be generated via automated annotation in accordance with one or more embodiments described herein.

First, consider FIG. 20. In various embodiments, some of the plurality of cleaned medical images 204 can already be assigned ground-truth annotations (e.g., a ground-truth classification label, a ground-truth segmentation mask, a ground-truth regression output). However, others of the plurality of cleaned medical images 204 can instead not yet be assigned ground-truth annotations. Whichever of the plurality of cleaned medical images 204 are already assigned ground-truth annotations can be referred to as a set of annotated cleaned medical images 2002. In contrast, whichever of the plurality of cleaned medical images 204 are not yet assigned ground-truth annotations can be referred to as a set of unannotated cleaned medical images 2004. In various instances, the set of annotated cleaned medical images 2002 can comprise s images, for any suitable positive integer s<n: an annotated cleaned medical image 2002(1) to an annotated cleaned medical image 2002(s). In various cases, the set of unannotated cleaned medical images 2004 can comprise t images, for any suitable positive integer t<n where t+s=n: an unannotated cleaned medical image 2004(1) to an unannotated cleaned medical image 2004(t). In various aspects, the curation component 118 can electronically assign, to respective ones of the set of unannotated cleaned medical images 2004, ground-truth annotations that are already assigned to the set of annotated cleaned medical images 2002, based on the plurality of concatenated embeddings 602.

As a non-limiting example, the curation component 118 can iterate through each of the set of unannotated cleaned medical images 2004 as follows. For each given unannotated cleaned medical image, the curation component 118 can determine whether any of the set of annotated cleaned medical images 2002 has a concatenated embedding that is sufficiently similar to (e.g., that has more than a threshold amount of similarity with; that is a neighbor of or otherwise within the same cluster as) the concatenated embedding of the given unannotated cleaned medical image. If such an annotated cleaned medical image is identified, then the curation component 118 can assign to the given unannotated cleaned medical image whatever ground-truth annotation is already assigned to that identified annotated cleaned medical image. Thus, the given unannotated cleaned medical image can now be considered as being annotated. The curation component 118 can repeat this procedure until each of the set of unannotated cleaned medical images 2004 is either: assigned a respective ground-truth annotation; or determined to be so dissimilar from each of the set of annotated cleaned medical images 2002 so as to warrant not being assigned any of their ground-truth annotations). Thus, a technician need not expend excessive effort or time on manual annotation of the set of unannotated cleaned medical images 2004.

FIG. 21 illustrates a computer-implemented method 2100 that can facilitate dataset curation via automated annotation in accordance with one or more embodiments described herein.

In various embodiments, acts 1002, 1004, and 1006 can be as described above.

In various aspects, act 2102 can include separating, by the device (e.g., via 118), the plurality of medical images into a set of annotated medical images (e.g., 2002) and a set of unannotated medical images (e.g., 2004).

In various instances, act 2104 can include selecting, by the device (e.g., via 118), an unannotated medical image.

In various cases, act 2106 can include identifying, by the device (e.g., via 118), which annotated medical image in the set of annotated medical images has a concatenated embedding that is most similar to that of the selected unannotated medical image.

In various aspects, act 2108 can include converting, by the device (e.g., via 118), the selected unannotated medical image into a new annotated medical image by assigning to it whatever annotation (e.g., whatever ground-truth) corresponds to the identified annotated medical image.

In various instances, act 2110 can include determining, by the device (e.g., via 118), whether the set of unannotated medical images is now empty. If so, the computer-implemented method 2100 can end. If not, the computer-implemented method 2100 can proceed back to act 2104.

In various aspects, the curation component 118 can utilize any suitable combination of any of the above-mentioned curation techniques (e.g., duplicate removal, outlier removal, cluster-based splitting, automated annotation) to create the curated training dataset 604. In any case, the training component 120 can electronically cause the untrained vision model 108 to be trained on the curated training dataset 604.

As a non-limiting example, the training component 120 can electronically share the curated training dataset 604 with a computing device that is responsible for training or configuring the untrained vision model 108, along with an instruction to begin or commence training.

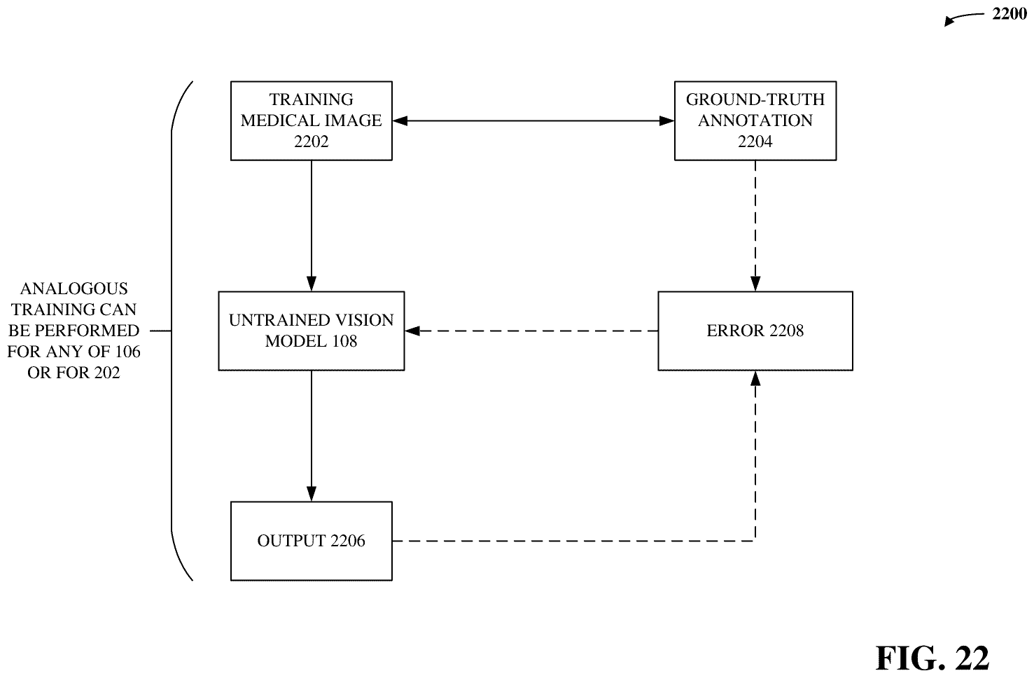

As another non-limiting example, the training component 120 can, in some cases, train the untrained vision model 108 using the curated training dataset 604. Non-limiting details are described with respect to FIG. 22.

FIG. 22 illustrates an example, non-limiting block diagram 2200 showing how the untrained vision model 108, or various other machine learning models described herein such as the image cleaning model 202 or any of the suite of pre-trained vision models 106, can be trained in accordance with one or more embodiments.

In various aspects, prior to beginning training, the trainable internal parameters (e.g., convolutional kernels, weight matrices, bias values) of the untrained vision model 108 (or of the image cleaning model 202, or of any of the suite of pre-trained vision models 106) can be initialized in any suitable fashion (e.g., via random initialization).

In various embodiments, there can be a training medical image 2202 and a ground-truth annotation 2204. In some cases, if the untrained vision model 108 is being trained, then the training medical image 2202 can be any suitable medical image from the curated training dataset 604, and the ground-truth annotation 2204 can be whatever correct or accurate inferencing task result (e.g., correct or accurate classification label, correct or accurate segmentation mask, correct or accurate regression output) that is known or deemed to correspond to the training medical image 2202. In other cases, if the image cleaning model 202 is being trained, then the training medical image 2202 can be any suitable medical image depicting overlaid text, and the ground-truth annotation 2204 can be whatever correct or accurate cleaned image is known or deemed to show the same visual content as the training medical image 2202 but without such overlaid text. In yet other cases, if any of the suite of pre-trained vision models 106 is being trained, then the training medical image 2202 can be any suitable medical image, and the ground-truth annotation 2204 can be whatever correct or accurate inferencing task result (e.g., correct or accurate classification label, correct or accurate segmentation mask, correct or accurate regression output) that is known or deemed to correspond to the training medical image 2202.

In various aspects, the untrained vision model 108 (or the image cleaning model 202, or any of the suite of pre-trained vision models 106) can be executed on the training medical image 2202, thereby causing the untrained vision model 108 (or the image cleaning model 202, or any of the suite of pre-trained vision models 106) to produce an output 2206. In some cases, if the untrained vision model 108 is being trained, then the output 2206 can be any suitable predicted or inferred inferencing task result (e.g., predicted or inferred classification label, predicted or inferred segmentation mask, predicted or inferred regression output) that the untrained vision model 108 believes should correspond to the training medical image 2202. In other cases, if the image cleaning model 202 is being trained, then the output 2206 can be any suitable predicted or inferred cleaned image that the image cleaning model 202 believes should correspond to the training medical image 2202. In yet other cases, if any of the suite of pre-trained vision models 106 is being trained, then the output 2206 can be any suitable predicted or inferred inferencing task result (e.g., predicted or inferred classification label, predicted or inferred segmentation mask, predicted or inferred regression output) that such pre-trained vision model believes should correspond to the training medical image 2202. In any case, if the untrained vision model 108 (or the image cleaning model 202, or any of the suite of pre-trained vision models 106) has no far undergone no or little training, then the output 2206 can be highly inaccurate (e.g., can be very different from the ground-truth annotation 2204).

In various aspects, an error 2208 (e.g., mean absolute error, mean squared error, cross-entropy error) between the output 2206 and the ground-truth annotation 2204 can be computed. In various instances, the trainable internal parameters of the untrained vision model 108 (or of the image cleaning model 202, or of any of the suite of pre-trained vision models 106) can be incrementally updated via backpropagation (e.g., stochastic gradient descent) based on the error 2208.

In various cases, such execution-and-update procedure can be repeated any suitable number of image-annotation pairs. This can ultimately cause the trainable internal parameters of the untrained vision model 108 (or of the image cleaning model 202, or of any of the suite of pre-trained vision models 106) to become iteratively optimized for accurately performing its inferencing task. In various aspects, any suitable training batch sizes, any suitable error/loss functions, or any suitable training termination criteria can be utilized during such training.

Although the herein disclosure mainly describes the untrained vision model 108 (or the image cleaning model 202, or any of the suite of pre-trained vision models 106) as being trained in supervised fashion, this is a mere non-limiting example for ease of explanation and illustration. In various embodiments, any other suitable training paradigms can be used to train the untrained vision model 108 (or the image cleaning model 202, or any of the suite of pre-trained vision models 106), such as unsupervised training or reinforcement learning, any of which may be federated or unfederated.

In various embodiments, once the untrained vision model 108 is trained, it can be added to the suite of pre-trained vision models 106 (e.g., the cardinality of the suite of pre-trained vision models 106 can be considered as going from m to m+1). Thus, the untrained vision model 108 can, after being trained, be leveraged by the curation system 102 so as to help generate concatenated embeddings for medical images that might be used for curation or training of future untrained vision models. Adding the untrained vision model 108, after training, to the suite of pre-trained vision models 106 can be considered as progressively or incrementally improving the substantive breadth of future concatenated embeddings.

In various aspects, the curation component 118 can perform or otherwise facilitate any suitable dataset exploration functionalities, so as to help show or explain to a technician how the plurality of cleaned medical images 204 has been or is being curated. As a non-limiting example, if the curation component 118 generates the plurality of clusters 1602 (e.g., either on a dataset-wide basis or on a class-wise basis), the curation component 118 can, in some cases, electronically identify centroidal images of such clusters. Indeed, when given a cluster of cleaned medical images, the mean pairwise similarity scores of the cleaned medical images within that cluster can be computed (e.g., ignoring images that are outside of the cluster), and whichever cleaned medical image in that given cluster has a highest pairwise similarity score can be referred to as the centroidal image, or the most representative image, of that given cluster. The curation component 118 can, in some instances, render on any suitable electronic display or screen the centroidal image of each of the plurality of clusters 1602, thereby giving a technician a better understanding of how the plurality of cleaned medical images 204 is being curated. As another non-limiting example, the curation component 118 can render a plotted visualization of the plurality of clusters 1602, by compressing each of the plurality of concatenated embeddings 602 into a two-dimensional or three-dimensional vector. Such compression can be facilitated via any suitable dimensionality-reduction technique, such as t-distributed stochastic neighbor embedding (t-SNE), uniform manifold approximation and projection (UMAP), or principal component analysis (PCA). Such visualization or plotting can, as above, help to give a technician a better understanding of how the plurality of cleaned medical images 204 is being curated.

The herein disclosure has so far mainly described various embodiments in which curation of the plurality of cleaned medical images 204 is performed in the concatenated embedding space (e.g., is performed by comparing the plurality of concatenated embeddings 602 to each other). However, it should be appreciated that these are mere non-limiting examples and that the curation component 118 can, in supplementary or complementary fashion, apply to the plurality of cleaned medical images 204 any suitable pixel-space or voxel-space curation techniques. As a non-limiting example, the curation component 118 can remove from the plurality of cleaned medical images 204 any image that exhibits an extreme or outlying brightness level or contrast level.

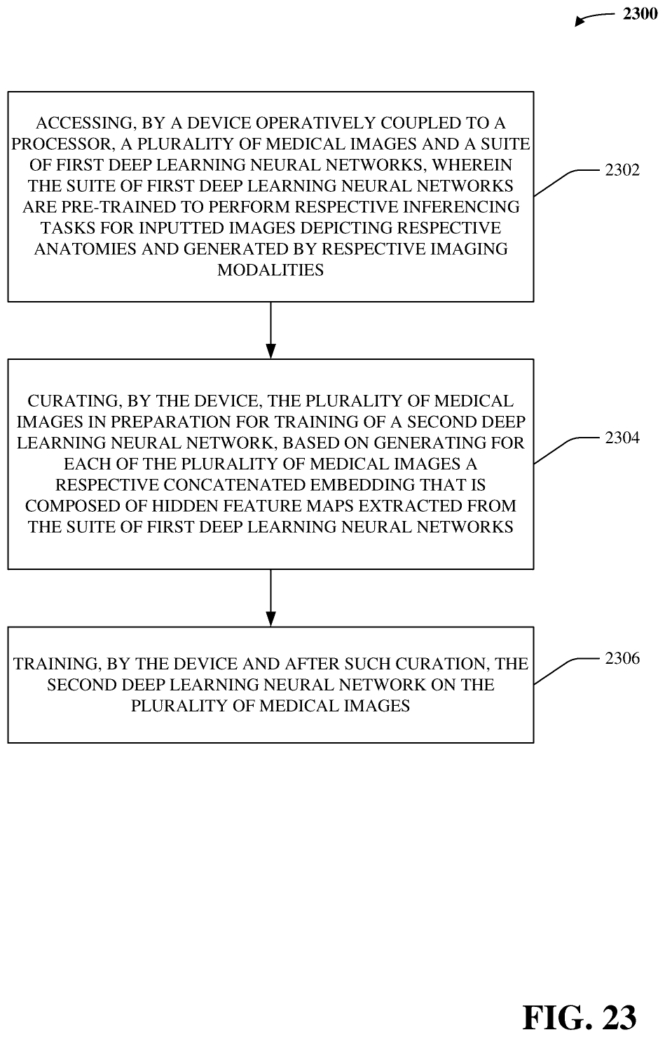

FIG. 23 illustrates a flow diagram of an example, non-limiting computer-implemented method 2300 that can facilitate training image curation via hidden feature concatenation in accordance with one or more embodiments described herein. In various cases, the curation system 102 can perform the computer-implemented method 2300.

In various embodiments, act 2302 can include accessing, by a device (e.g., via 114) operatively coupled to a processor (e.g., 110), a plurality of medical images (e.g., 104) and a suite of first deep learning neural networks (e.g., 106), wherein the suite of first deep learning neural networks are pre-trained to perform respective inferencing tasks for inputted images depicting respective anatomies or generated by respective imaging modalities.

In various aspects, act 2304 can include curating, by the device (e.g., via 118), the plurality of medical images in preparation for training of a second deep learning neural network (e.g., 108), based on generating for each of the plurality of medical images a respective concatenated embedding (e.g., 602) that is composed of hidden feature maps (e.g., 806) extracted from the suite of first deep learning neural networks.

In various instances, act 2306 can include training, by the device (e.g., via 120) and after such curation, the second deep learning neural network on at least some of the plurality of medical images (e.g., curation can be considered as ultimately converting 104 to 604).

Although not explicitly shown in FIG. 23, the second deep learning neural network can join, after such training, the suite of first deep learning neural networks, such that the second deep learning neural network can contribute to concatenated embeddings used to train future deep learning neural networks.

Although not explicitly shown in FIG. 23, the curating can comprise: identifying, by the device (e.g., via 118), two or more medical images having concatenated embeddings that are within a threshold margin of similarity of each other; and removing, by the device (e.g., via 118), all but one of those two or more medical images from the plurality of medical images (e.g., duplicate removal, such as shown with respect to FIG. 10).

Although not explicitly shown in FIG. 23, the curating can comprise: identifying, by the device (e.g., via 118), one or more medical images having concatenated embeddings whose mean pairwise similarities with concatenated embeddings of others of the plurality of medical images are below a threshold margin; and removing, by the device (e.g., via 118), those one or more medical images from the plurality of medical images (e.g., outlier removal, such as shown with respect to FIG. 13).

Although not explicitly shown in FIG. 23, the plurality of medical images can respectively correspond to modality classes, anatomy classes, or view classes, and the mean pairwise similarities can be computed on a class-wise basis (rather than on a dataset-wide basis).

Although not explicitly shown in FIG. 23, the curating can comprise: separating, by the device (e.g., via 118), the plurality of medical images into two or more clusters (e.g., 1602) of medical images according to their concatenated embeddings; and forming, by the device (e.g., via 118), a training dataset (e.g., 604) that includes a first percentage of each of the two or more clusters of medical images, wherein the device can train the second deep learning neural network on the training dataset and not on a remainder (e.g., 1604) of the plurality of medical images.

Although not explicitly shown in FIG. 23, the computer-implemented method 2300 can comprise: validating, by the device (e.g., via 120), the second deep learning neural network on the remainder of the plurality of medical images after training.

Although not explicitly shown in FIG. 23, a first medical image (e.g., one of 2002) in the plurality of medical images can correspond to a first ground-truth annotation, two or more second medical images (e.g., two or more of 2004) in the plurality of medical images can lack ground-truth annotations, and the curating can comprise: identifying, by the device, which of the two or more second medical images have concatenated embeddings that are within a threshold margin of, or that are in a same cluster as, that of the first medical image; and assigning, by the device (e.g., via 118), the first ground-truth annotation to such identified ones of the two or more second medical images (e.g., auto-annotation, such as shown with respect to FIG. 21).

Although not explicitly shown in FIG. 23, the computer-implemented method 2300 can comprise: removing, by the device (e.g., via 116), via execution of a third deep learning neural network (e.g., 202), and prior to curation of the plurality of medical images, text, legends, or logos that are superimposed over respective ones of the plurality of medical images.

In various instances, machine learning algorithms or models can be implemented in any suitable way to facilitate any suitable aspects described herein. To facilitate some of the above-described machine learning aspects of various embodiments, consider the following discussion of artificial intelligence (AI). Various embodiments described herein can employ artificial intelligence to facilitate automating one or more features or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system or environment from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z₁, z₂, z₃, z₄, zₙ), to a confidence that the input belongs to a class, as by f(z)=confidence(class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

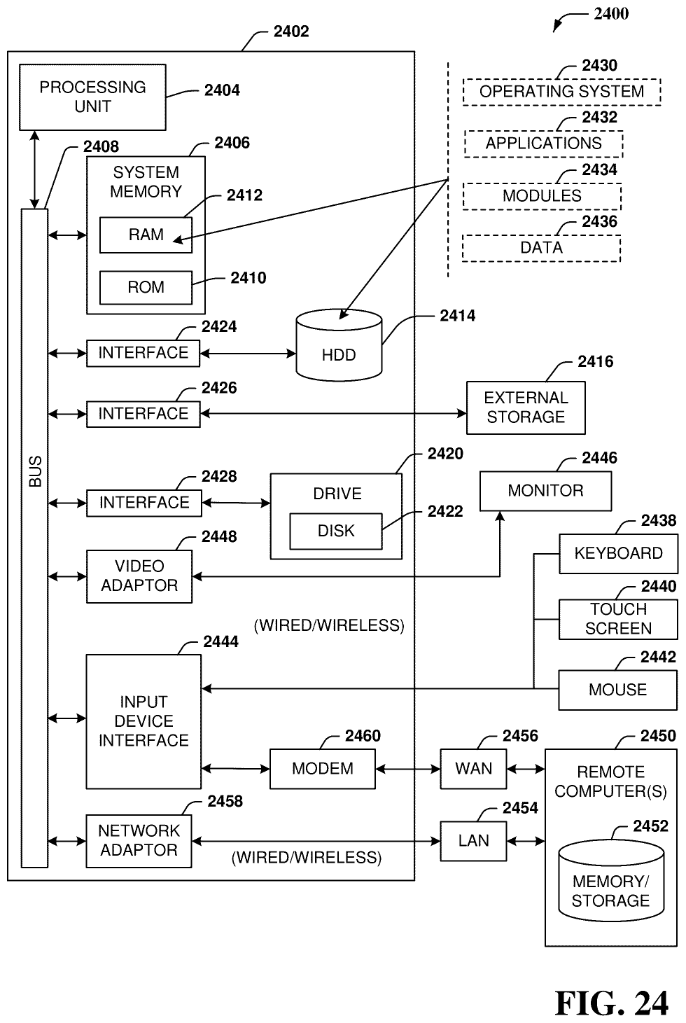

In order to provide additional context for various embodiments described herein, FIG. 24 and the following discussion are intended to provide a brief, general description of a suitable computing environment 2400 in which the various embodiments of the embodiment described herein can be implemented. While the embodiments have been described above in the general context of computer-executable instructions that can run on one or more computers, those skilled in the art will recognize that the embodiments can be also implemented in combination with other program modules or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 24, the example environment 2400 for implementing various embodiments of the aspects described herein includes a computer 2402, the computer 2402 including a processing unit 2404, a system memory 2406 and a system bus 2408. The system bus 2408 couples system components including, but not limited to, the system memory 2406 to the processing unit 2404. The processing unit 2404 can be any of various commercially available processors. Dual microprocessors and other multi-processor architectures can also be employed as the processing unit 2404.

The system bus 2408 can be any of several types of bus structure that can further interconnect to a memory bus (with or without a memory controller), a peripheral bus, and a local bus using any of a variety of commercially available bus architectures. The system memory 2406 includes ROM 2410 and RAM 2412. A basic input/output system (BIOS) can be stored in a non-volatile memory such as ROM, erasable programmable read only memory (EPROM), EEPROM, which BIOS contains the basic routines that help to transfer information between elements within the computer 2402, such as during startup. The RAM 2412 can also include a high-speed RAM such as static RAM for caching data.

The computer 2402 further includes an internal hard disk drive (HDD) 2414 (e.g., EIDE, SATA), one or more external storage devices 2416 (e.g., a magnetic floppy disk drive (FDD) 2416, a memory stick or flash drive reader, a memory card reader, etc.) and a drive 2420, e.g., such as a solid state drive, an optical disk drive, which can read or write from a disk 2422, such as a CD-ROM disc, a DVD, a BD, etc. Alternatively, where a solid state drive is involved, disk 2422 would not be included, unless separate. While the internal HDD 2414 is illustrated as located within the computer 2402, the internal HDD 2414 can also be configured for external use in a suitable chassis (not shown). Additionally, while not shown in environment 2400, a solid state drive (SSD) could be used in addition to, or in place of, an HDD 2414. The HDD 2414, external storage device(s) 2416 and drive 2420 can be connected to the system bus 2408 by an HDD interface 2424, an external storage interface 2426 and a drive interface 2428, respectively. The interface 2424 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 2402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 2412, including an operating system 2430, one or more application programs 2432, other program modules 2434 and program data 2436. All or portions of the operating system, applications, modules, or data can also be cached in the RAM 2412. The systems and methods described herein can be implemented utilizing various commercially available operating systems or combinations of operating systems.

Computer 2402 can optionally comprise emulation technologies. For example, a hypervisor (not shown) or other intermediary can emulate a hardware environment for operating system 2430, and the emulated hardware can optionally be different from the hardware illustrated in FIG. 24. In such an embodiment, operating system 2430 can comprise one virtual machine (VM) of multiple VMs hosted at computer 2402. Furthermore, operating system 2430 can provide runtime environments, such as the Java runtime environment or the .NET framework, for applications 2432. Runtime environments are consistent execution environments that allow applications 2432 to run on any operating system that includes the runtime environment. Similarly, operating system 2430 can support containers, and applications 2432 can be in the form of containers, which are lightweight, standalone, executable packages of software that include, e.g., code, runtime, system tools, system libraries and settings for an application.

Further, computer 2402 can be enable with a security module, such as a trusted processing module (TPM). For instance with a TPM, boot components hash next in time boot components, and wait for a match of results to secured values, before loading a next boot component. This process can take place at any layer in the code execution stack of computer 2402, e.g., applied at the application execution level or at the operating system (OS) kernel level, thereby enabling security at any level of code execution.

A user can enter commands and information into the computer 2402 through one or more wired/wireless input devices, e.g., a keyboard 2438, a touch screen 2440, and a pointing device, such as a mouse 2442. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 2404 through an input device interface 2444 that can be coupled to the system bus 2408, but can be connected by other interfaces, such as a parallel port, an IEEE 1394 serial port, a game port, a USB port, an IR interface, a BLUETOOTH® interface, etc.

A monitor 2446 or other type of display device can be also connected to the system bus 2408 via an interface, such as a video adapter 2448. In addition to the monitor 2446, a computer typically includes other peripheral output devices (not shown), such as speakers, printers, etc.

The computer 2402 can operate in a networked environment using logical connections via wired or wireless communications to one or more remote computers, such as a remote computer(s) 2450. The remote computer(s) 2450 can be a workstation, a server computer, a router, a personal computer, portable computer, microprocessor-based entertainment appliance, a peer device or other common network node, and typically includes many or all of the elements described relative to the computer 2402, although, for purposes of brevity, only a memory/storage device 2452 is illustrated. The logical connections depicted include wired/wireless connectivity to a local area network (LAN) 2454 or larger networks, e.g., a wide area network (WAN) 2456. Such LAN and WAN networking environments are commonplace in offices and companies, and facilitate enterprise-wide computer networks, such as intranets, all of which can connect to a global communications network, e.g., the Internet.

When used in a LAN networking environment, the computer 2402 can be connected to the local network 2454 through a wired or wireless communication network interface or adapter 2458. The adapter 2458 can facilitate wired or wireless communication to the LAN 2454, which can also include a wireless access point (AP) disposed thereon for communicating with the adapter 2458 in a wireless mode.

When used in a WAN networking environment, the computer 2402 can include a modem 2460 or can be connected to a communications server on the WAN 2456 via other means for establishing communications over the WAN 2456, such as by way of the Internet. The modem 2460, which can be internal or external and a wired or wireless device, can be connected to the system bus 2408 via the input device interface 2444. In a networked environment, program modules depicted relative to the computer 2402 or portions thereof, can be stored in the remote memory/storage device 2452. It will be appreciated that the network connections shown are example and other means of establishing a communications link between the computers can be used.

When used in either a LAN or WAN networking environment, the computer 2402 can access cloud storage systems or other network-based storage systems in addition to, or in place of, external storage devices 2416 as described above, such as but not limited to a network virtual machine providing one or more aspects of storage or processing of information. Generally, a connection between the computer 2402 and a cloud storage system can be established over a LAN 2454 or WAN 2456 e.g., by the adapter 2458 or modem 2460, respectively. Upon connecting the computer 2402 to an associated cloud storage system, the external storage interface 2426 can, with the aid of the adapter 2458 or modem 2460, manage storage provided by the cloud storage system as it would other types of external storage. For instance, the external storage interface 2426 can be configured to provide access to cloud storage sources as if those sources were physically connected to the computer 2402.

The computer 2402 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

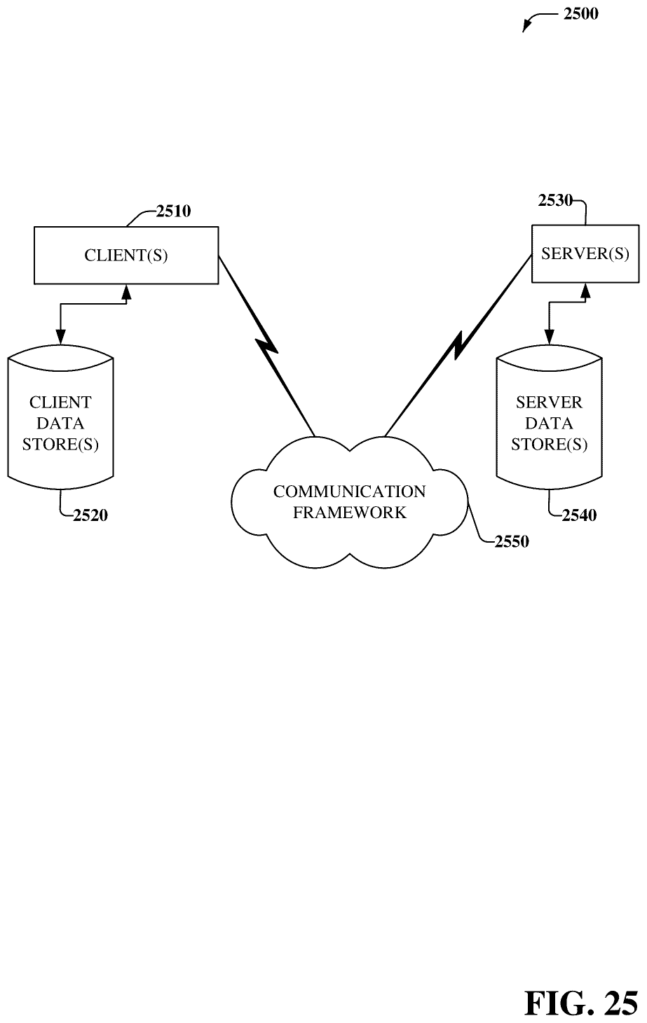

FIG. 25 is a schematic block diagram of a sample computing environment 2500 with which the disclosed subject matter can interact. The sample computing environment 2500 includes one or more client(s) 2510. The client(s) 2510 can be hardware or software (e.g., threads, processes, computing devices). The sample computing environment 2500 also includes one or more server(s) 2530. The server(s) 2530 can also be hardware or software (e.g., threads, processes, computing devices). The servers 2530 can house threads to perform transformations by employing one or more embodiments as described herein, for example. One possible communication between a client 2510 and a server 2530 can be in the form of a data packet adapted to be transmitted between two or more computer processes. The sample computing environment 2500 includes a communication framework 2550 that can be employed to facilitate communications between the client(s) 2510 and the server(s) 2530. The client(s) 2510 are operably connected to one or more client data store(s) 2520 that can be employed to store information local to the client(s) 2510. Similarly, the server(s) 2530 are operably connected to one or more server data store(s) 2540 that can be employed to store information local to the servers 2530.

Various embodiments may be a system, a method, an apparatus or a computer program product at any possible technical detail level of integration. The computer program product can include a computer readable storage medium (or media) having computer readable program instructions thereon for causing a processor to carry out aspects of various embodiments. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a solid state drive such as M.2 (including non-volatile memory express (NVMe) or serial advanced technology attachment (SATA)), a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of various embodiments can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform various aspects.

Various aspects are described herein with reference to flowchart illustrations or block diagrams of methods, apparatus (systems), and computer program products according to various embodiments. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowcharts and block diagrams in the Figures illustrate the architecture, functionality, and operation of possible implementations of systems, methods, and computer program products according to various embodiments. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that various aspects can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

The herein disclosure describes non-limiting examples. For case of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a processor that executes computer-executable components stored in a non-transitory computer-readable memory, wherein the computer-executable components comprise:
an access component that accesses a plurality of medical images and a suite of first deep learning neural networks, wherein the suite of first deep learning neural networks are pre-trained to perform respective inferencing tasks for inputted images depicting respective anatomies or generated by respective imaging modalities;
a curation component that curates the plurality of medical images in preparation for training of a second deep learning neural network, based on generating for each of the plurality of medical images a respective concatenated embedding that is composed of hidden feature maps extracted from the suite of first deep learning neural networks; and
a training component that trains, after such curation, the second deep learning neural network on at least some of the plurality of medical images.

2. The system of claim 1, wherein the second deep learning neural network joins, after such training, the suite of first deep learning neural networks, such that the second deep learning neural network contributes to concatenated embeddings used to train future deep learning neural networks.

3. The system of claim 1, wherein the curation component curates the plurality of medical images based on:
identifying two or more medical images having concatenated embeddings that are within a threshold margin of similarity of each other; and
removing all but one of those two or more medical images from the plurality of medical images.

4. The system of claim 1, wherein the curation component curates the plurality of medical images based on:
identifying one or more medical images having concatenated embeddings whose mean pairwise similarities with concatenated embeddings of others of the plurality of medical images are below a threshold margin; and
removing those one or more medical images from the plurality of medical images.

5. The system of claim 4, wherein the plurality of medical images respectively correspond to modality classes, anatomy classes, or view classes, and wherein the mean pairwise similarities are computed on a class-wise basis.

6. The system of claim 1, wherein the curation component curates the plurality of medical images based on:
separating the plurality of medical images into two or more clusters of medical images according to their concatenated embeddings; and
forming a training dataset that includes a first percentage of each of the two or more clusters of medical images, wherein the training component trains the second deep learning neural network on the training dataset and not on a remainder of the plurality of medical images.

7. The system of claim 6, wherein the training component validates the second deep learning neural network on the remainder of the plurality of medical images after training.

8. The system of claim 1, wherein a first medical image in the plurality of medical images corresponds to a first ground-truth annotation, wherein two or more second medical images in the plurality of medical images lack ground-truth annotations, and wherein the curation component curates the plurality of medical images based on:
identifying which of the two or more second medical images have concatenated embeddings that are within a threshold margin of, or that are in a same cluster as, that of the first medical image; and
assigning the first ground-truth annotation to such identified ones of the two or more second medical images.

9. The system of claim 1, wherein the computer-executable components further comprise:
a cleaning component that removes, via execution of a third deep learning neural network and prior to curation of the plurality of medical images, text, legends, or logos that are superimposed over respective ones of the plurality of medical images.

10. A computer-implemented method, comprising:
accessing, by a device operatively coupled to a processor, a plurality of medical images and a suite of first deep learning neural networks, wherein the suite of first deep learning neural networks are pre-trained to perform respective inferencing tasks for inputted images depicting respective anatomies or generated by respective imaging modalities;
curating, by the device, the plurality of medical images in preparation for training of a second deep learning neural network, based on generating for each of the plurality of medical images a respective concatenated embedding that is composed of hidden feature maps extracted from the suite of first deep learning neural networks; and
training, by the device and after such curation, the second deep learning neural network on at least some of the plurality of medical images.

11. The computer-implemented method of claim 10, wherein the second deep learning neural network joins, after such training, the suite of first deep learning neural networks, such that the second deep learning neural network contributes to concatenated embeddings used to train future deep learning neural networks.

12. The computer-implemented method of claim 10, wherein the curating comprises:
identifying, by the device, two or more medical images having concatenated embeddings that are within a threshold margin of similarity of each other; and
removing, by the device, all but one of those two or more medical images from the plurality of medical images.

13. The computer-implemented method of claim 10, wherein the curating comprises:
identifying, by the device, one or more medical images having concatenated embeddings whose mean pairwise similarities with concatenated embeddings of others of the plurality of medical images are below a threshold margin; and
removing, by the device, those one or more medical images from the plurality of medical images.

14. The computer-implemented method of claim 13, wherein the plurality of medical images respectively correspond to modality classes, anatomy classes, or view classes, and wherein the mean pairwise similarities are computed on a class-wise basis.

15. The computer-implemented method of claim 10, wherein the curating comprises:
separating, by the device, the plurality of medical images into two or more clusters of medical images according to their concatenated embeddings; and
forming, by the device, a training dataset that includes a first percentage of each of the two or more clusters of medical images, wherein the device trains the second deep learning neural network on the training dataset and not on a remainder of the plurality of medical images.

16. The computer-implemented method of claim 15, further comprising:
validating, by the device, the second deep learning neural network on the remainder of the plurality of medical images after training.

17. The computer-implemented method of claim 10, wherein a first medical image in the plurality of medical images corresponds to a first ground-truth annotation, wherein two or more second medical images in the plurality of medical images lack ground-truth annotations, and wherein the curating comprises:
identifying, by the device, which of the two or more second medical images have concatenated embeddings that are within a threshold margin of, or that are in a same cluster as, that of the first medical image; and
assigning, by the device, the first ground-truth annotation to such identified ones of the two or more second medical images.

18. The computer-implemented method of claim 10, further comprising:
removing, by the device, via execution of a third deep learning neural network, and prior to curation of the plurality of medical images, text, legends, or logos that are superimposed over respective ones of the plurality of medical images.

19. A computer program product for facilitating training image curation via hidden feature concatenation, the computer program product comprising a non-transitory computer-readable memory having program instructions embodied therewith, the program instructions executable by a processor to cause the processor to:
access a plurality of medical images and a suite of first deep learning neural networks, wherein the suite of first deep learning neural networks are pre-trained to perform respective inferencing tasks for inputted images depicting respective anatomies or generated by respective imaging modalities;
curate the plurality of medical images in preparation for training of a second deep learning neural network, based on generating for each of the plurality of medical images a respective concatenated embedding that is composed of hidden feature maps extracted from the suite of first deep learning neural networks; and
train, after such curation, the second deep learning neural network on at least some of the plurality of medical images.

20. The computer program product of claim 19, wherein the processor curates the plurality of medical images based on:
separating the plurality of medical images into two or more clusters of medical images according to their concatenated embeddings; and
forming a training dataset that includes a first percentage of each of the two or more clusters of medical images, wherein the processor trains the second deep learning neural network on the training dataset and not on a remainder of the plurality of medical images.
